(19) United States
(12) Patent Application Publication
(10) Pub. No.: US 2007/0024450 A1
(43) Pub. Date: Feb. 1, 2007

(54) Terminal device, server, safety confirmation system, safety confirmation method, control program and computer-readable recording medium

(76) Inventors: Ricardo T. Shichiku, Kashihara-shi (JP); Masako Yoshimura, Yamatokooriyama-shi (JP); Atsushi Yamashita, Soraku-gun (JP)

Correspondence Address: NIXON & VANDERHYE, PC, 901 NORTH GLEBE ROAD, 11TH FLOOR, ARLINGTON, VA, 22203, US

(21) Appl. No.: 11/452,420

(22) Filed: Jun. 14, 2006

(30) Foreign Application Priority Data
Jun. 17, 2005 (JP) 2005-178561

(51) Int. Cl. G08B 23/00

(52) U.S. Cl. 340/573.1

(57) ABSTRACT

A terminal device carried by a person being monitored comprises a position obtaining section; an activity range information storage section; an information storage section; an activity detection section; a communication section; and a self-person and circumstance authentication section.

This Nonprovisional application claims priority under 35 U.S.C. §119(a) on Patent Application 2005-178561 filed in Japan on Jun. 17, 2005, the entire contents of which are hereby incorporated by reference.

### BACKGROUND OF THE INVENTION

1. Field of the Invention

The present invention relates to: a safety confirmation system capable of confirming the whereabouts and a currently placed circumstance (e.g., a safety circumstance) of a person being monitored (e.g., the elderly or children who require monitoring for safety) when the person being monitored is confronted by an incident (e.g., abduction); a safety confirmation method using the safety confirmation system; a terminal device on the person being monitored side and a server used for the safety confirmation system and the safety confirmation method; a control program for causing a computer to execute the safety confirmation method; and a computer-readable reading medium having the control program recorded thereon.

2. Description of the Related Art

Conventionally, as such a type of safety confirmation system for monitoring an activity range and an activity pattern of a person being monitored by using a GPS (Global Positioning System) locator-equipped mobile phone device, for example, Reference 1 discloses an area monitoring system.

FIG. 11 is a block diagram showing a schematical structural example of a conventional area monitoring system disclosed in Reference 1.

In FIG. 11, the conventional area monitoring system 100 includes a GPS locator-equipped mobile phone device 101, a position searching center 102 and a service center 103, a mobile phone device 104, a GPS satellite 105 and a base station/relay station 106. The GPS locator-equipped mobile phone device 101 is carried by a person being monitored. The position searching center 102 and the service center 103 perform a position searching process for the GPS locator-equipped mobile phone device 101. The mobile phone device 104 is carried by a monitoring person and is provided with information from the service center 103 at the time of an unusual event. The GPS satellite 105 is capable of providing positional information of the GPS locator-equipped mobile phone device 101.

The position searching center 102 regularly requests positional information to the GPS locator-equipped mobile phone device 101 on a predetermined schedule and receives the positional information from the GPS locator-equipped mobile phone device 101.

The service center 103 requests the positional information to the position searching center 102 and receives the positional information from the position searching center 102, which has been obtained from the GPS locator-equipped mobile phone device 101. When the positional information is out of the area which is previously determined by the monitoring person, within a predetermined area, or when the change of the positional information within a predetermined time is unusual, the fact that the positional information is out of the area, within a predetermined area or the fact that the change of the positional information within a predetermined time is unusual is notified to the mobile terminal device 104 on the person monitoring side by electronic mail.

Owing to the structure described above, first, a positional information searching request for the GPS locator-equipped mobile phone device 101 on the person being monitored side is issued to the position searching center 102 from the service center 103.

Next, the positional information of the GPS locator-equipped mobile phone device 101, which is regularly obtained from the GPS locator-equipped mobile phone device 101, is transmitted to the service center 103 by the position searching center 102.

As described above, when the obtained positional information is out of the area which is previously determined by the monitoring person, within a predetermined area, or when the change of the positional information within a predetermined time is unusual, then the service center 103 which has obtained the positional information of the GPS locator-equipped mobile phone device 101 from the position searching center 102 transmits the fact that the positional information is out of the area, within the predetermined area or the fact that the change of the positional information within the predetermined time is unusual to the mobile phone device 104 on the monitoring person side by electronic mail.

Owing to this, when a person being monitored (e.g., the elderly or children who require monitoring for safety) has strayed off a specific area, or in contrast thereto, when the person being monitored enters the specific area, or if there is unusual movement of the person being monitored or if there is no movement of the person being monitored for a predetermined time, it is possible for the monitoring person side to detect them by using the GPS locator-equipped mobile phone device 101.

[Reference 1] Japanese Laid-Open Publication No. 2004-328018

### SUMMARY OF THE INVENTION

However, although the aforementioned conventional area monitoring system 100 can detect movement information of the person being monitored (e.g., the elderly or children), it is not possible to confirm the intent of the person being monitored, whether the person being monitored has strayed off a specific activity pattern on their own will or has been forcibly strayed off by a threat or the like.

Herein, in order to inform the monitoring person (e.g., parent) of the intent of the person being monitored (e.g., child), when the person being monitored is being threatened by someone or the like, there is a concern that the person being monitored will be exposed to danger in a method using a voice call or an obvious-looking SOS button. Thus, both in a case with the intent of the person being monitored and a case without the intent of the person being monitored, it is necessary to inform the monitoring person of the intent of the person being monitored without the threatening person being aware thereof by using a similar procedure.

The present invention is intended to solve the conventional problems described above. The objective of the present invention is to provide: a safety confirmation system in which a monitoring person side can confirm the intent of a person being monitored when the person being monitored strays off a predetermined activity range or activity pattern; a safety confirmation method using the safety confirmation system; a terminal device and a server used for the safety confirmation system and the safety confirmation method; a control program for causing a computer to execute the safety confirmation method; and a computer-readable recording medium having the control program recorded thereon.

A terminal device on a person being monitored side, carried by the person being monitored, according to the present invention includes: a position obtaining section for obtaining positional information of the terminal device from a positional information providing section; an activity range information storage section for storing information of an activity range and an activity pattern of the person being monitored, the activity range and the activity pattern being set by a monitoring person or the person being monitored; an information storage section for a monitoring person for storing at least a contact address of the monitoring person; an activity detection section for detecting the relationship between the positional information and the range stored in the activity range information storage section; a communication section for informing the contact address of the terminal device on the monitoring person side of the relationship between the positional information and the stored range; and a self-person and circumstance authentication section for performing a self-person and circumstance authentication process in accordance with a request from the terminal device on the monitoring person side in order to confirm the identity of the person being monitored and also to confirm the circumstance in which the person being monitored is being placed, wherein a result information of the self-person and circumstance authentication indicating whether the circumstance in which the person being monitored is being placed is safe is informed to the terminal device on the monitoring person side by the communication section, thereby the objective described above being achieved.

A terminal device on a person being monitored side, carried by the person being monitored, according to the present invention includes: a position obtaining section for obtaining positional information of the terminal device from a positional information providing section; a communication section for sending the positional information to a server, and for receiving a self-person and circumstance authentication request from the server; and a self-person and circumstance authentication section for performing a self-person and circumstance authentication process in accordance with the self-person and circumstance authentication request in order to confirm the identity of the person being monitored and also to confirm the circumstance in which the person being monitored is being placed, wherein a result information of the self-person and circumstance authentication indicating whether the circumstance in which the person being monitored is being placed is safe is informed to the server side by the communication section, thereby the objective described above being achieved.

Preferably, in the terminal device according to the present invention, the self-person and circumstance authentication section has a plurality of self-person and circumstance authentication functions, the plurality of self-person and circumstance authentication functions being selectable in accordance with a state of the person being monitored, wherein the self-person and circumstance authentication section is capable of informing the monitoring person or the server of the result information of the self-person and circumstance authentication by the self-person and circumstance authentication function selected by the person being monitored.

Furthermore, preferably, in the terminal device according to the present invention, the terminal device further includes an authentication information storage section for storing a plurality of self-person and circumstance authentication information, the plurality of self-person and circumstance authentication information being selectable in accordance with a state of the person being monitored, wherein the self-person and circumstance authentication section performs the self-person and circumstance authentication process by using the self-person and circumstance authentication information which is stored in the authentication information storage section.

Still further, preferably, in the terminal device according to the present invention, the self-person and circumstance authentication information is registered in the authentication information storage section, the self-person and circumstance authentication information indicating whether the person being monitored is in a safe situation or in a dangerous situation.

Still further, preferably, in the terminal device according to the present invention, the self-person and circumstance authentication section includes a sensor section for sensing at least one of a finger print, an iris of an eye and a face, and the self-person and circumstance authentication process is performed by verifying (i) the information of at least one of the finger print, the iris of the eye and the face measured by the sensor section and (ii) information of at least one of a finger print, an iris of an eye and a face registered corresponding to the information of at least one of the finger print, the iris of the eye and the face measured by the sensor section as the self-person and circumstance authentication information.

Still further, preferably, in the terminal device according to the present invention, the plurality of self-person and circumstance authentication information selectable in accordance with the state of the person being monitored includes a finger print information of one finger and a finger print information of another finger different from the one finger, and the self-person and circumstance authentication information is set in the authentication information storage section so as to indicate a safe situation when the person being monitored uses the finger print information of the one finger for verification and a dangerous situation when the person being monitored uses the finger print information of the another finger for verification.

Still further, preferably, in the terminal device according to the present invention, an information storage section for the monitoring person stores one or more contact addresses of one or more terminal devices on one or more monitoring persons' side or a plurality of contact addresses of a plurality of terminal devices on a monitoring person side along with the order of priority thereof can be stored.

Still further, preferably, in the terminal device according to the present invention, the positional information providing section includes a GPS satellite, a position augmentation system which uses a differential GPS (DGPS) other than the GPS satellite, a base station or relay station for a mobile phone device or a combination thereof.

Still further, preferably, in the terminal device according to the present invention, the terminal device further includes a positional information storage section for storing the positional information at each predetermined time.

Still further, preferably, in the terminal device according to the present invention, the terminal device further includes a speed detection section for detecting a moving speed with which the position of the positional information changes, wherein the contact address of the terminal device on the monitoring person side or the server is informed by using the communication section of the fact that the position of the positional information changes at the speed faster than or equal to that previously set when the position of the positional information changes at a speed faster than or equal to that previously set.

Still further, preferably, in the terminal device according to the present invention, the terminal device further includes a speed detection section for detecting a moving speed with which the position of the positional information changes, wherein the contact address of the terminal device on the monitoring person side or the server is informed by using the communication section of the fact that the position of the positional information does not change for the time longer than or equal to that previously set when the position of the positional information does not change for a time longer than or equal to that previously set.

Still further, preferably, in the terminal device according to the present invention, the contact address of the terminal device on the monitoring person side or the server is informed by using the communication section of the fact that the positional information is out of the range stored in the activity range information storage section when the positional information is out of the range stored in the activity range information storage section.

Still further, preferably, in the terminal device according to the present invention, the contact address of the terminal device on the monitoring person side or the server is informed at each predetermined time by using the communication section of the fact that the positional information is within the range stored in the activity range information storage section when the positional information is within the range stored in the activity range information storage section.

Still further, preferably, in the terminal device according to the present invention, the terminal device further includes a backup power supply section having a power supply not being able to be disconnected by an external operation, wherein even when a normal power supply is disconnected, the normal power supply is backed up by the backup power supply section, and the positional information obtaining section can at least obtain the positional information.

Still further, preferably, in the terminal device according to the present invention, when a contact with the terminal device on the monitoring person side cannot be established by the communication section, the positional information storage section stores the positional information obtained by the position obtaining section and clock time information when the positional information has been obtained by the position obtaining section.

Still further, preferably, in the terminal device according to the present invention, the positional information storage section stores clock time information from a GPS satellite as the clock time information.

Still further, preferably, in the terminal device according to the present invention, the terminal device further includes a clock section, wherein the positional information storage section stores a clock time from the clock section as the clock time information.

Still further, preferably, in the terminal device according to the present invention, the terminal device further includes an alarm output section for generating an alarm sound, wherein the alarm sound is generated by the alarm output section so as to notify the self-person and circumstance authentication request when a self-person and circumstance authentication request is issued from the terminal device on the monitoring person side or the server to the terminal device on the person being monitored side.

Still further, preferably, in the terminal device according to the present invention, the terminal device further includes an audio output section for storing a terminal beeping sound corresponding to the self-person and circumstance authentication request and reproducing the stored sound, wherein the sound registered in the audio output section is reproduced as to notify the self-person and circumstance authentication request when a self-person and circumstance authentication request is issued from the terminal device on the monitoring person side or the server to the terminal device on the person being monitored side.

Still further, preferably, in the terminal device according to the present invention, the terminal device further includes an information storage section for a person being monitored for storing information for identifying the person being monitored.

A server according to the present invention for monitoring a terminal device on a person being monitored side according to the present invention includes an activity range information storage section for storing an activity range and activity pattern of the person being monitored, the activity range and activity pattern of the person being monitored being set by a monitoring person or the person being monitored side; an information storage section for a monitoring person for storing at least a contact address of the terminal device on the monitoring person; a communication section for communicating with the terminal device on the person being monitored side and with the terminal device on the monitoring person side; a positional information storage section for storing positional information obtained from the terminal device on the person being monitored side by using the communication section; an activity detection section for detecting the relationship between the positional information and the range stored in the activity range information storage section; and an authentication request section for issuing a self-person and circumstance authentication request to the terminal device on the person being monitored side by using the communication section when the relationship between the positional information and the range stored in the activity range information storage section has a predetermined relationship, thereby the objective described above being achieved.

Preferably, in the server according to the present invention, when the relationship has the predetermined relationship, the authentication request section informs the contact address of the terminal device on the monitoring person side of the fact that the relationship has the predetermined relationship, and issues the self-person and circumstance authentication request to the terminal device on the person being monitored side in accordance with a request from the terminal device on the monitoring person side.

Furthermore, preferably, in the server according to the present invention, when the relationship has the predetermined relationship, the authentication request section automatically issues the self-person and circumstance authentication request to the terminal device on the person being monitored side.

Still further, preferably, in the server according to the present invention, when the positional information is out of the range stored in the activity range information storage section in the predetermined relationship, the positional information is obtained from the terminal device on the person being monitored side by using the communication section at an time interval shorter than that when the positional information is within the range.

Still further, preferably, in the server according to the present invention, when the positional information is out of the range stored in the activity range information storage section in the predetermined relationship, the positional information is obtained from the terminal device on the person being monitored side by using the communication section at an time interval longer than that when the positional information is within the range.

Still further, preferably, in the server according to the present invention, the positional information is obtained from the terminal device on the person being monitored side by using the communication section at an interval, when the remaining charge of the power supply of the terminal device on the person being monitored side is determined to be lower than a predetermined value, the interval being longer than that of before the remaining charge of the power supply of the terminal device on the person being monitored side is determined to be low.

Still further, preferably, in the server according to the present invention, the determination that the remaining charge of the power supply of the terminal device on the person being monitored side is lower than the predetermined value determines that the remaining charge of the power supply is low when a received voltage level is lower than a predetermined value, the received voltage level received when the positional information is obtained from the terminal device on the person being monitored side by using the communication section.

Still further, preferably, in the server according to the present invention, the information storage section for the monitoring person stores one or more contact addresses of the terminal device on the monitoring person side along with the order of priority thereof.

Still further, preferably, in the server according to the present invention, the contact address of the terminal device on the monitoring person side is informed by using the communication section of the fact that the positional information cannot be obtained from the terminal device on the person being monitored at each predetermined time when the positional information cannot be obtained from the terminal device on the person being monitored at each predetermined time, the contact address being stored in the information storage section for the monitoring person.

Still further, preferably, in the server according to the present invention, the positional information storage section stores the positional information obtained from the terminal device on the person being monitored side and clock time information when the positional information has been obtained from the terminal device on the person being monitored side.

Still further, preferably, in the server according to the present invention, the server further includes an information storage section for a person being monitored for storing information for identifying the person being monitored.

Still further, preferably, in the server according to the present invention, the positional information storage section stores the positional information obtained at each predetermined time.

Still further, preferably, in the server according to the present invention, the server further includes a speed detection section for detecting a moving speed with which the position of the positional information changes, wherein the contact address of the terminal device on the monitoring person side is informed by using the communication section of the fact that the positional information changes at the speed faster than or equal to that previously set when the position of the positional information changes at a speed faster than or equal to that previously set.

Still further, preferably, in the server according to the present invention, the server further includes a speed detection section for detecting a moving speed with which the position of the positional information changes, wherein the contact address of the terminal device on the monitoring person side is informed by using the communication section of the fact that the positional information does not change for the time longer than or equal to that previously set when the position of the positional information does not change for a time longer than or equal to that previously set.

Still further, preferably in the server according to the present invention, when a contact with the terminal device on the monitoring person side cannot be established by the communication section, the positional information storage section stores (i) the positional information obtained from the terminal device on the person being monitored and (ii) at least one of clock time information when the positional information has been obtained from the position obtaining section, when the positional information has been obtained at the terminal device on the person being monitored and when a contact with the terminal device on the monitoring person side has not been be established.

Still further, preferably, in the server according to the present invention, the server further includes a clock section, the positional information storage section stores a clock time from the clock section as the clock time information.

A safety confirmation system according to the present invention includes: a terminal device on a person being monitored side described above according to the present invention; a server described above according to the present invention; and a terminal device on a monitoring person side for monitoring the terminal device on the person being monitored side, the terminal device on the monitoring person side having a communication section for performing a communication with the terminal device on the person being monitored side and with the server, wherein the terminal device on the monitoring person side is informed, from the terminal device on the person being monitored side and/or the server, of the fact that the positional information of the terminal device on the person being monitored side is out the activity range or activity pattern previously set when positional information of the terminal device on the person being monitored side is out an activity range or activity pattern previously set, a self-person and circumstance authentication is requested to the terminal device on the person being monitored side in accordance with a request from the terminal device on the monitoring person side so as to perform a self-person and circumstance authentication process, and result information of the self-person and circumstance authentication process is informed to the terminal device on the monitoring person side so as to notify the terminal device on the monitoring person side of the circumstance of the person being monitored based on the result information of the self-person and circumstance authentication process, thereby the objective described above being achieved.

A safety confirmation system according to the present invention includes: a terminal device on a person being monitored side described above according to the present invention; and a terminal device on a monitoring person side for monitoring the terminal device on the person being monitored side, the terminal device on the monitoring person side having a communication section for performing a communication with the terminal device on the person being monitored side, wherein the terminal device on the monitoring person side is informed by the terminal device on the person being monitored side of the fact that the positional information of the terminal device on the person being monitored side is out the activity range or activity pattern previously stored when positional information of the terminal device on the person being monitored side is out an activity range or activity pattern previously set, a self-person and circumstance authentication is requested to the terminal device on the person being monitored side in accordance with a request from the terminal device on the monitoring person side so as to perform a self-person and circumstance authentication process, and result information of the self-person and circumstance authentication process is informed to the terminal device on the monitoring person side so as to notify the terminal device on the monitoring person side of the circumstance of the person being monitored based on the result information of the self-person and circumstance authentication process, thereby the objective described above being achieved.

A safety confirmation method according to the present invention controlled with a computer control using; a terminal device on the person being monitored side described above according to the present invention; a server described above according to the present invention; and a terminal device on a monitoring person side for monitoring the terminal device on the person being monitored side, the terminal device on the monitoring person having a communication section for performing a communication with the terminal device on the person being monitored side and with the server, respectively, the method on the server side including: a step of informing the terminal device on the monitoring person side, from the server, of the fact that positional information of the terminal device on the person being monitored side is out an activity range or activity pattern previously set when the positional information of the terminal device on the person being monitored side is out the activity range or activity pattern previously set; a step of requesting a self-person and circumstance authentication to the terminal device on the person being monitored side from the sever in accordance with a request from the terminal device on the monitoring person side; and an authentication result information informing step of obtaining, at the server side, result information of the self-person and circumstance authentication which has been performed at the terminal device on the person being monitored side and contacting the terminal device on the monitoring person side from the server, wherein a circumstance of the person being monitored is notified to the terminal device on the monitoring person side based on the result information of the self-person and circumstance authentication, thereby the objective described above being achieved.

A safety confirmation method according to the present invention controlled with a computer control using; a terminal device on a person being monitored side described above according to the present invention; and a terminal device on a monitoring person side for monitoring the terminal device on the person being monitored side, the terminal device on the monitoring person having a communication section for performing a communication with the terminal device on the person being monitored side, the method on the terminal device on the person being monitored side including: a step of informing the terminal device on the monitoring person side, from the terminal device on the person being monitored side, of the fact that positional information of the terminal device on the person being monitored side is out an activity range or activity pattern previously set when the positional information of the terminal device on the person being monitored side is out the activity range or activity pattern previously set; a step of requesting a self-person and circumstance authentication to the terminal device on the person being monitored side in accordance with a request from the terminal device on the monitoring person side; and an authentication result information informing step of informing the terminal device on the monitoring person side of result information of the self-person and circumstance authentication, the self-person and circumstance authentication which has been performed at the terminal device on the person being monitored side, wherein a circumstance of the person being monitored is informed to the terminal device on the monitoring person side based on the result information of the self-person and circumstance authentication, thereby the objective described above being achieved.

Preferably, in the safety confirmation method according to the present invention, the result information of the self-person and circumstance authentication has been authenticated by the person being monitored and when an authentication result indicates a dangerous situation, the authentication result information informing step includes a step of informing the terminal device on the monitoring person side of information indicating “the person being monitored is in a dangerous situation, and thus inform the person being monitored or inform the police”.

Furthermore, preferably, in the safety confirmation method according to the present invention, the result information of the self-person and circumstance authentication has been authenticated by the person being monitored and when an authentication result indicates a normal situation, the authentication result information informing step includes a step of informing the terminal device on the monitoring person side of information indicating “the person being monitored is not in a dangerous situation, and thus inform the person being monitored and give them an appropriate instruction”.

Still further, preferably, in the safety confirmation method according to the present invention, the result information of the self-person and circumstance authentication has not been authenticated by the person being monitored, the authentication result information informing step includes a step of requesting a self-person and circumstance authentication a plurality of times, and furthermore of informing the terminal device on the monitoring person side of information indicating “the person being monitored is in a dangerous situation, or an unusual situation exists in which the authentication has been performed by a third person” when the authentication by the person being monitored has not been obtained within a predetermined time.

Still further, preferably, in the safety confirmation method according to the present invention, when the self-person and circumstance authentication process has not been performed, the authentication result information informing step includes a step of requesting that a warning be issued to the terminal device on the person being monitored side or outputting a warning to the terminal device on the person being monitored side, and furthermore of informing the terminal device on the monitoring person side of information indicating “the person being monitored is in a dangerous situation” when the authentication has not been performed within a predetermined time.

A control program according to the present invention causes a computer to execute each step of a safety confirmation method described above according to the present invention, thereby the objective described above being achieved.

A computer-readable recording medium according to the present invention has a control program stored described above according to the present invention thereon, thereby the objective described above being achieved.

Owing to the structure described above, the function of the present invention will be described hereinafter.

In the present invention, a self-person (person themselves) and circumstance authentication section (e.g., finger print sensor) and a positional information obtaining section (e.g., a position sensor) for obtaining positional information by communicating with a GPS and the like are mounted on a terminal device on the person being monitored side.

When the positional information of the terminal device on the person being monitored side, which has been obtained from a GPS satellite and the like by the positional information obtaining section has strayed off an activity range or an activity pattern previously set, the fact that the positional information of the terminal device on the person being monitored has strayed off is informed to a monitoring person, and a self-person and circumstance authentication is requested to the terminal device on the person being monitored side in accordance with a request from the monitoring person or a server.

The result of the self-person and circumstance authentication is informed to the monitoring person via the server and the like and therefore, it is possible for the monitoring person to confirm the state of the person being monitored based on the authentication result.

For example, the result of the self-person and circumstance authentication has been authenticated by the person being monitored themselves. However, when the authentication which shows a dangerous situation has been performed, the monitoring person determines that the person being monitored is in a dangerous situation, and can perform responses such as contacting the person being monitored or informing the police.

The result of the self-person and circumstance authentication has been authenticated by the person being monitored themselves. When the authentication which shows a normal situation has been performed, the monitoring person determines that the person being monitored is not in a dangerous situation, and can contact the person being monitored and give them an appropriate instruction.

Furthermore, when the result of the self-person and circumstance authentication has not been authenticated by the person being monitored themselves, the monitoring person requests the self-person and circumstance authentications a plurality of times, and furthermore when the authentication by the person being monitored has not been obtained, the monitoring person determines that the person being monitored is in a dangerous situation, or an unusual situation exists in which the authentication has been performed by a third person, they can perform responses such as informing the police.

Furthermore, when the self-person and circumstance authentication has not been performed, a warning is issued to the person being monitored, and when the authentication has not been performed within a predetermined time, the monitoring person determines that the person being monitored is in a dangerous situation and can perform responses such as informing the police.

As described above, according to the present invention, when positional information of a person being monitored is out of a predetermined activity range or activity pattern, it is possible to contact a monitoring person of the fact that the positional information of the person being monitored is out of a predetermined activity range or activity pattern and inform the monitoring person of whether the person being monitored is in a dangerous situation or a safe situation by using a previously-registered individual authentication method in response to a request from the monitoring person.

When an authentication function (e.g., a finger print sensor) is provided in a terminal device (e.g., mobile phone device) carried by the person being monitored, it is possible to prevent a third person other than the person being monitored from responding by impersonating the person being monitored themselves.

Furthermore, if authentication information, which indicates whether the person being monitored is in a dangerous situation or a safe situation, is only known by the person being monitored, it is possible to contact the monitoring person of the authentication information without the third person being aware of it.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a structural example of relevant parts of a safety confirmation system according to an Embodiment of the present invention.

FIG. 2 is a flowchart for explaining an Embodiment of a safety confirmation method using the safety confirmation system in FIG. 1.

FIG. 3 is a block diagram showing a structural example of a communication path of the safety confirmation system in FIG. 1 FIG. 4 is a block diagram showing a specific structural example of the mobile phone device on the person being monitored in FIG. 3.

FIG. 5 is a block diagram showing a specific structural example of the service center in FIG. 3.

FIG. 6 is a flowchart for explaining a registration setting flow (No.1) to the service center in FIG. 3.

FIG. 7 is a flowchart for explaining a registration setting flow (No.2) to the service center in FIG. 3.

FIG. 8 is a flowchart for explaining the flow of the change of the registered contents for the service center in FIG. 3.

FIG. 9 is a flowchart for explaining the flow of the change of the registered contents for the service center in FIG. 3.

FIG. 10 is a flowchart for explaining the flow when the positional information of the mobile phone device on the person being monitored side in FIG. 3 has strayed off the registered “activity range or activity pattern”.

FIG. 11 is a block diagram showing a schematical structural example of a conventional area monitoring system disclosed in Reference 1.

### DESCRIPTION OF THE PREFERRED EMBODIMENTS

Hereinafter, embodiments of a safety confirmation system and a safety confirmation method according to the present invention will be described with reference to the accompanying drawings.

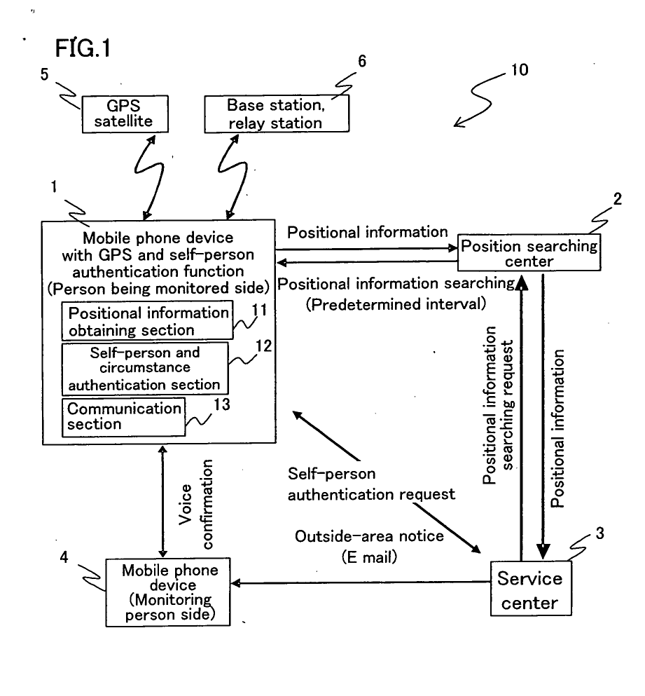

FIG. 1 is a block diagram showing a structural example of relevant parts of a safety confirmation system according to an Embodiment of the present invention.

In FIG. 1, a safety confirmation system 10 according to the Embodiment includes a mobile phone device 1, a position searching center 2 and a service center 3, a mobile phone device 4 and a GPS satellite 5 and a base station/relay station 6. The mobile phone device 1 is carried by a person being monitored (e.g., the elderly or children who require monitoring for safety) and is provided as a terminal device for performing a position searching process and a self-person and circumstance authentication process. The position searching center 2 and the service center 3 are provided as a server for obtaining positional information and the result information of a self-person and circumstance authentication from the mobile phone device 1. The mobile phone device 4 is carried by a monitoring person side and is provided as a terminal device provided with information from the service center 3 or the mobile phone device 1 at the time of an unusual event. The GPS satellite 5 and the base station/relay station 6 are capable of providing the positional information of the mobile phone device 1 on the person being monitored side.

The mobile phone device 1 on the person being monitored side includes a positional information obtaining section 11, a self-person and circumstance authentication section 12 and a communication section 13. The positional information obtaining section 11 obtains positional information of itself from the GPS satellite 5 and the base station/relay station 6. The self-person and circumstance authentication section 12 performs a self-person and circumstance authentication process. The communication section 13 is capable of performing a communication with the position searching center 2 and the service center 3 and with the mobile phone device 4 on the monitoring person side, respectively.

The positional information obtaining section 11 obtains the positional information of itself by performing a communication with the GPS satellite 5 and the like or obtains the positional information from a position augmentation system which uses a differential GPS (DGPS), by performing a communication with a satellite other than the GPS satellite 5 or the base station/relay station 6 for the mobile phone device.

The self-person and circumstance authentication section 12 performs a self-person and circumstance authentication process by using a finger print sensor as a sensor section or the like. A plurality of authentication information which corresponds to the state of the self-person is registered in the self-person and circumstance authentication section 12, and verification is performed on the self-person and circumstance authentication process. Herein, the mobile phone device 1 is used as a terminal device carried by the person being monitored. However, the terminal device is not necessarily a mobile phone device. As long as a terminal device includes the positional information obtaining section 11 and the self-person and circumstance authentication section 12, it can be used as the terminal device carried by the person being monitored.

The position searching center 2 regularly requests positional information to the mobile phone device 1 on the person being monitored side on a predetermined schedule and receives the positional information from the mobile phone device 1 on the person being monitored side.

The service center 3 stores the obtained positional information of the mobile phone device 1 on the person being monitored side, an activity range and activity pattern of the person being monitored and a contact address of the monitoring person, and performs a communication with the monitoring person and with the person being monitored. Additionally, the service center 3 requests positional information to the position searching center 2 and receives the positional information from the position searching center 2, which has been obtained from the mobile phone device 1 on the person being monitored. When the positional information is out of an activity area which is previously determined by the monitoring person or within a predetermined activity area, or when the change of the positional information within a predetermined time is unusual, the fact that the positional information is out of the activity area which is previously determined by the monitoring person or within the predetermined activity area, or when the change of the positional information within the predetermined time is unusual is notified to the mobile terminal device 4 on the person monitoring side. In FIG. 1, the position searching center 2 and the service center 3 are separately structured. However, the position searching center 2 and the service center 3 can be combined to form one structure.

The mobile phone device 4 on the monitoring person side includes a communication section for performing a communication with the mobile phone device 1 on the person being monitored side and with the service center 3, respectively.

Owing to the structure described above, the operation thereof will be described hereinafter.

When a positional information searching process is requested to the mobile phone device 1 on the person being monitored side from the service center 3 via the position searching center 2, the mobile phone device 1 obtains positional information of itself via the GPS satellite 5 or the base station/relay station 6 and notifies the service center 3 of the positional information of the mobile phone device 1 (i.e., positional information of the person being monitored) from the mobile phone device 1 via the position searching center 2.

At the service center 3, it is matched and detected whether the positional information of the person being monitored obtained in such a manner is out of an activity range or activity pattern set for the person being monitored. When the positional information of the person being monitored is out of the activity range or activity pattern set for the person being monitored, the service center 3 contacts the mobile phone device 4 on the monitoring person side. In this example, a “notification of a person being monitored being out of area” is sent to the mobile phone device 4 on the monitoring person side from the service center 3 by an E-mail. However, other methods other than the E-mail can be used.

In the case of the “notification of a person being monitored being out of area”, the mobile phone device 4 on the monitoring person side and/or the service center 3 issues a self-person and circumstance authentication request to the mobile phone device 1 on the person being monitored side.

The self-person and circumstance authentication is performed by verifying: inherent information (specifically, information such as finger print, iris of eye, face and the like), intrinsic to the person being monitored, among the self-person and circumstance authentication information registered by the person being monitored; and the information measured by the self-person and circumstance authentication section 12 (e.g., sensor). The information indicating the state of the person being monitored, which corresponds to matched information or unmatched information in the verifiation, will become result information of the self-person and circumstance authentication.

The result information of the self-person and circumstance authentication is informed to the mobile terminal device 4 on the monitoring person side and/or the service center 3 from the mobile phone device 1 on the person being monitored side. It is possible to perform a safety confirmation with a voice from the monitoring person side based on the result information of the self-person and circumstance authentication.

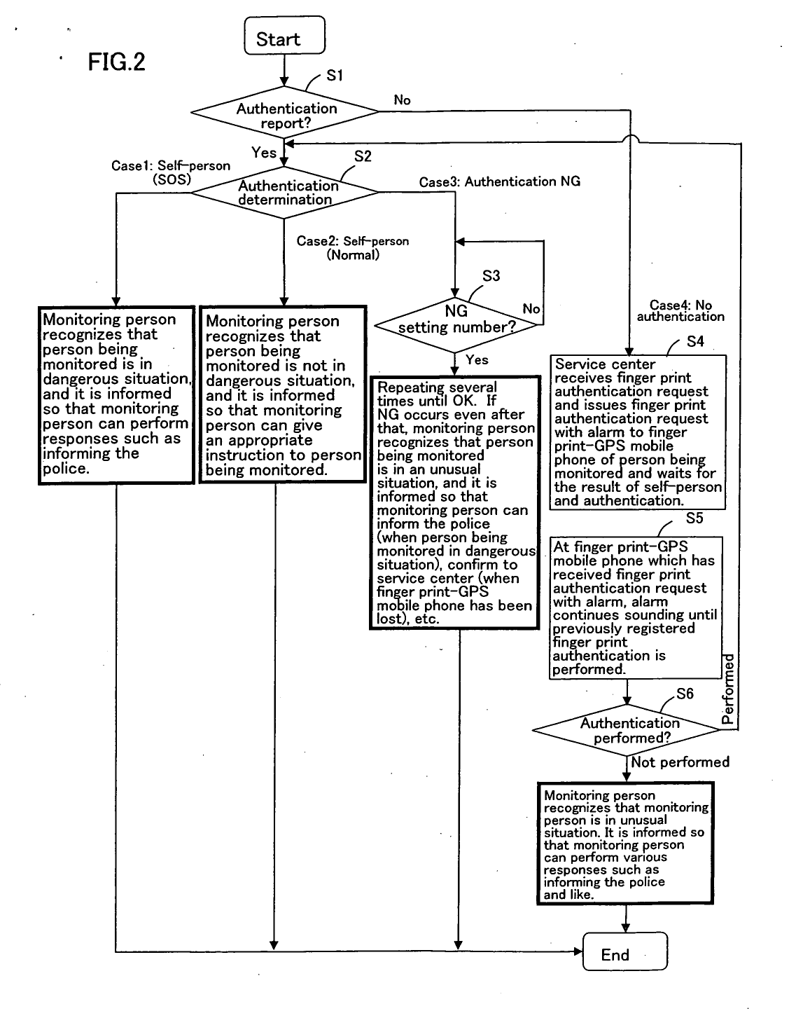

Hereinafter, the response to be made by the monitoring person based on the result information of the self-person and circumstance authentication from the mobile phone device 1 on the person being monitored will be described with reference to a flowchart in FIG. 2.

There are four types of self-person and circumstance authentication are considered as the result information: “self-person (SOS)”, “self-person (normal)”, “self-person (NG)” and “No authentication”.

In step S1, it is detected whether the self-person and circumstance authentication result has been reported to the mobile terminal device 4 on the monitoring person side and/or the service center 3 within a predetermined time for the self-person and circumstance authentication request from the mobile phone device 4 on the monitoring person and/and the service center 3.

In step S2, when the self-person and circumstance authentication result has been reported (when the self-person and circumstance authentication has been performed), an authentication determination process is performed in order to determine one of a first “self-person (SOS)”, a second “self-person (normal)” and a third “self-person (NG)” from the self-person and circumstance authentication result. This result of the determination is reported to the mobile phone device 4 on the monitoring person side from the service center 3 or the mobile phone device 1.

As for the first “self-person (SOS)”, the authentication has been performed by the person being monitored (person themselves; self-person) (normal). However, when the authentication indicating a dangerous situation in which an SOS is sent by the person being monitored has been performed (Case 1), it is recognized on the monitoring person side that “it is sensed that the person being monitored (self-person) is in a dangerous situation, and the monitoring person can perform responses such as contacting the person being monitored or informing the police”. This can be informed by voice to the mobile phone device 4 on the monitoring person side from the service center 3 and the like. Alternatively, this can be informed to the monitoring person side by displaying this on a display screen of the mobile phone device 4 on the monitoring person side.

As for the second “self-person (normal)”, the authentication has been performed by the person being monitored (self-person) (normal). When the authentication indicating a normal situation has been performed (Case 2), it is recognized on the monitoring person side that “it is determined that the person being monitored is not in a dangerous situation, and the monitoring person can contact the person being monitored and give an appropriate instruction to the person being monitored”. This can be informed by voice to the mobile phone device 4 on the monitoring side from the service center 3 and the like. Alternatively, this can be informed to the monitoring person side by displaying this on a display screen of the mobile phone device 4 on the monitoring person side.

As for the third “self-person (NG)”, when the authentication has not been performed by the person being monitored (Case 3), in step S3, in order to make sure, the self-person and circumstance authentication is caused to perform several times. Additionally, when the verification is unmatched (self-person (NG)) and furthermore, it is determined that the person who has performed the authentication is not the self-person, it is recognized on the monitoring person side that “it is determined that the person being monitored is in a dangerous situation, or the situation is an unusual situation being dealt with by a third person due to a loss of the mobile phone device 1 or the like, and the monitoring person can perform responses such as informing the police”. This can be informed by voice to the mobile phone device 4 on the monitoring side from the service center 3 and the like. Alternatively, this can be informed to the monitoring person side by displaying this on a display screen of the mobile phone device 4 on the monitoring person side.

In contrast, as the fourth “no authentication”, when the self-person and circumstance authentication has not been performed (Case 4), first, in step S4, the service center 3 receives a request from the monitoring person and the like, outputs a warning by sounding an alarm and the like to the mobile phone device 1 on the person being monitored side and requests the self-person and circumstance authentication (hereinafter, self-person and circumstance authentication request with alarm) such that the self-person and circumstance authentication is inevitably performed.

Next, in step S5, the mobile phone device 1 on the person being monitored side is caused to continue sounding an alarm until the self-person and circumstance authentication is performed.

Furthermore, in step S5, it is determined whether the self-person and circumstance authentication has been performed within a predetermined time. When the self-person and circumstance authentication has been performed within the predetermined time, the process proceeds to the self-person and circumstance authentication determination process in step S2. Thus, the monitoring person side can respond as shown in Cases 1 to 3 described above.

On the other hand, when the self-person and circumstance authentication has not been performed after the predetermined time has passed, it is recognized on the monitoring person side that “it is determined that the person being monitored is in a dangerous situation, or the situation is an unusual situation in which the person being monitored cannot respond due to a loss of the mobile phone device 1 or the like, and the monitoring person can perform various responses, such as informing the police”. This can be informed by voice to the mobile phone device 4 on the monitoring person side from the service center 3 and the like. Alternatively, this can be informed to the monitoring person side by displaying this on a display screen of the mobile phone device 4 on the monitoring person side. The alarm is used for causing the attention to be paid to the self-person and circumstance authentication request. Therefore, it can sound until the self-person and circumstance authentication process is performed.

As described above, when the self-person and circumstance authentication section 12 (e.g., fingerprint sensor) is provided in the mobile phone device 1 on the person being monitored side, the third person other than the person being monitored cannot respond by impersonating the person being monitored themselves. In addition to this, the setting of authentication information that the person being monitored is in a dangerous situation or is in a normal situation is information only known by the person being monitored. Thus, when the person being monitored verifies this with the authentication information (when the self-person and circumstance authentication is performed), it is possible to contact the monitoring person about the sending of SOS without the third person being aware of it. Furthermore, in a circumstance in which the intent of the person being monitored is not reported (e.g., when there is no response from the person being monitored), it can be determined that the situation is unusual.

Hereinafter, the Embodiment of the safety confirmation system according to the present invention will be described in further detail.

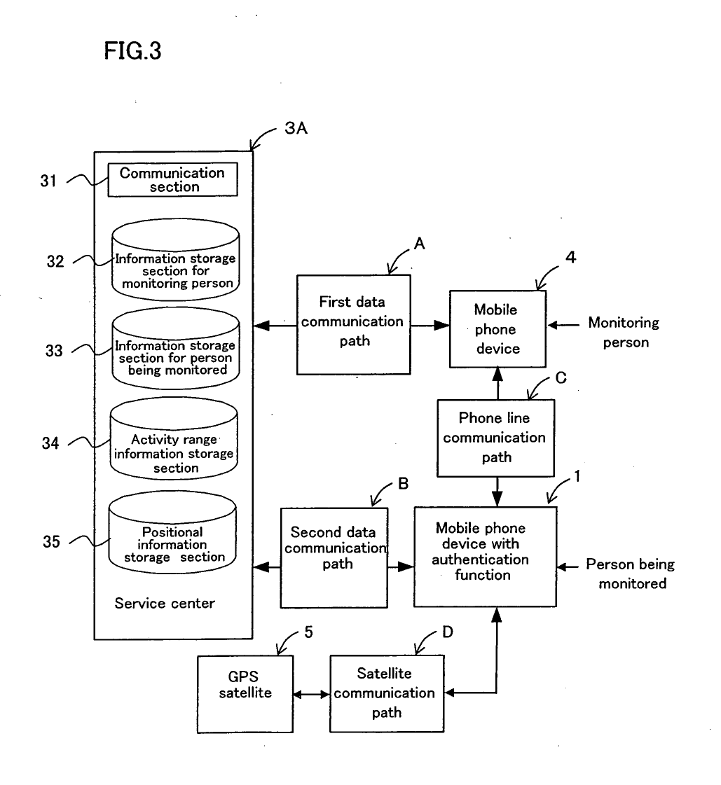

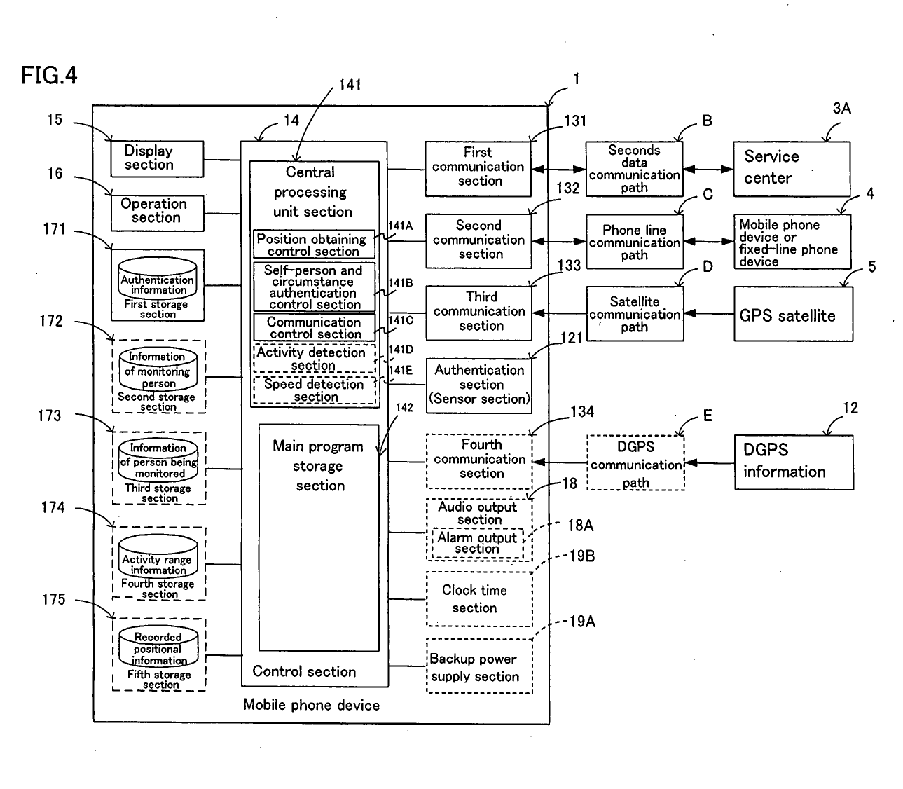

FIG. 3 is a block diagram showing a structural example of a communication path of the safety confirmation system 10. In FIG. 1, the position searching center 2 and the service center 3 are separately structured. However, in FIG. 3, they are combined and are shown as a service center 3A. This will be described hereinafter.

In FIG. 3, the safety confirmation system 10 in FIG. 1 includes a first data communication path A, a second data communication path B, a phone line communication path C and a satellite communication path D. The first data communication path A is provided for performing a communication between the service center 3A as a server and the mobile phone device 4 on the monitoring person side. The second data communication path B is provided for performing a communication between the service center 3A and the mobile phone device 1 on the person being monitored side. The phoneline communication path C is provided for performing a communication between the mobile phone device 4 on the monitoring person side and the mobile phone device 1 on the person being monitored. The satellite communication path D is provided for performing a communication between the mobile phone device 1 on the person being monitored side and the GPS satellite 5.

The service center 3A includes a communication section 31 for performing a communication with the mobile phone device 4 on the monitoring person side (the first data communication path A) and with the mobile phone device 1 on the person being monitored side (the second data communication path B). Additionally, the service center 3A includes an information storage section 32 for the monitoring person, an information storage section 33 for the person being monitored, an activity range information storage section 34 and a positional information storage section 35. The information storage section 32 for the monitoring person stores information of the monitoring person (e.g., ID, password and phone number) for identifying the contact address of the monitoring person or the monitoring person. The information storage section 33 for the person being monitored stores information of the person being monitored (e.g., ID, password and phone number) for identifying the person being monitored. The activity range information storage section 34 has activity range information of the person being monitored stored thereon and the like. The positional information storage section 35 obtains and stores positional information of the mobile phone device 1 on the person being monitored side.

The monitoring person can access the service center 3A from the mobile phone device 4 on the monitoring person side, which has a bi-directional communication function, via the first data communication path A, and can set and register an activity range and a positional and temporal activity pattern of the person being monitored in the activity range information storage section 34 of the service center 3A. In this manner, the information of the activity range and the positional and temporal activity pattern of the person being monitored can be registered by the monitoring person on their will and can be updated as appropriate.

The service center 3A can access the mobile phone device 1 carried by the person being monitored via the second data communication path B, confirm the position of the person being monitored and confirm whether the person carrying the mobile phone device 1 is the person being monitored themselves based on the self-person and circumstance authentication process.

The mobile phone device 4 on the monitoring person side and the mobile phone device 1 on the person being monitored side can conduct a conversation by normal voice by communicating with each other via the phone line communication path C.

The mobile phone device 1 on the person being monitored side can obtain positional information of itself from the GPS satellite 5 and the like via the satellite communication path D.

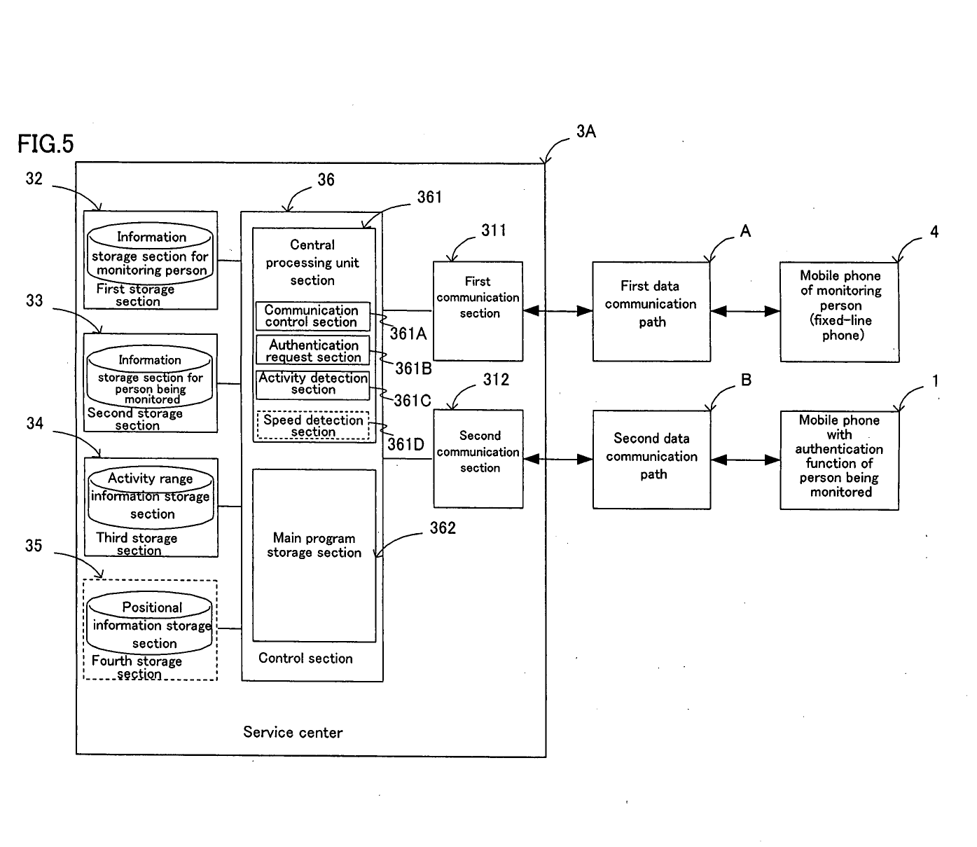

Herein, the mobile phone device 1 on the person being monitored side and the service center 3A, which play a principal role in the safety confirmation system 10 according to the Embodiment will be described in further detail with reference to FIGS. 4 and 5. In the figures, descriptions of the functions which have no relation to the present invention will be omitted.

FIG. 4 is a block diagram showing a specific structural example of the mobile phone device 1 on the person being monitored in FIG. 3.

In FIG. 4, the mobile phone device 1 on the person being monitored includes a control section 14, a display section 15, an operation section 16, a first storage section 171, a first communication section 131, a second communication section 132, a third communication section 133 and an authentication section 121. The control section 14 performs the entire control of the entire mobile phone device 1 on the person being monitored side. The display section 15 displays various information. The operation section 16 performs an input of various information. The first storage section 171 is provided as an authentication information storage section for storing a plurality of self-person and circumstance authentication information which corresponds to the state of the person being monitored. The first communication section 131 is provided as a person being monitored-server communication section for performing a transmission and reception of data between the first communication section 131 and the service center 3A. The second communication section 132 is provided as a monitoring person-person being monitored communication section for conducting a conversation by communicating with the mobile phone device 4 carried by the monitoring person or a commonly-used phone device. The third communication section 133 is provided as a position obtaining section for obtaining positional information of the mobile phone device 1 from the GPS satellite 5 and the like via the satellite communication path D. The authentication section 121 configures a sensor section for performing the self-person and circumstance authentication process. The positional information obtaining section 11 is configured by a position obtaining control section 141A in the control section 14 and the third communication section 133. The positional information obtaining section 11 obtains the positional information of itself from the GPS satellite 5 and the base station/relay station 6. The self-person and circumstance authentication section 12 is configured by a self-person and circumstance authentication control section 141B in the control section 14, the first storage section 171 and the authentication section 121. The self-person and circumstance authentication section 12 performs the self-person and circumstance authentication process.

Furthermore, the communication section 13 is configured by a communication control section 141C in the control section 14, the first communication section 131, the second communication section 132 and the third communication section 133. Communication can be established between the communication section 13 and the service center 3A and between the communication section 13 and the mobile phone device 4 on the monitoring person side and the like by the communication section 13.

The control section 14 includes a central processing unit section 141 having a CPU (Central Processing Unit) and a main program storage section 142 having a main control program stored thereon. Each control of the display section 15, the operation section 16, the first storage section 171, the first communication section 131, the second communication section 132, the third communication section 133 and the authentication section 121 is performed by utilizing the main program storage section 142.

In the first storage section 171, for example, a finger print data is stored as authentication information of the person being monitored, and the authentication information in the first storage section 171 is verified with the finger print data collected at the authentication section 121, which is configured by a finger print sensor and the like. The authentication information comprises a finger print data of the person being monitored and intent information of the person being monitored, which is made to correspond to the finger print data. Authentication information indicating whether the person being monitored is in a safe situation or in a dangerous situation is set in the authentication information. As an example thereof, when the person being monitored performs a fingerprint verification by the index finger of the right hand, the authentication information indicates a meaning of “safe”, and when the person being monitored performs a fingerprint verification by the middle finger of the right hand, the authentication information indicates a meaning of “SOS (Help)”.

The first communication section 131 can be connected to the service center 3A via the second data communication path B, which is capable of a bi-directional communication.

The second communication section 132 can be connected to the mobile phone device 4 on the monitoring person or a commonly-used phone device via the phone line communication path C.

The third communication section 133 can be connected to the GPS satellite 5 and the like via the satellite communication path D and can obtain the positional information of the mobile phone device 1 on the person being monitored.

The display section 15 is a display device which is mounted on the mobile phone device 1 on the person being monitored and has a liquid crystal display panel and the like used therefor. The person being monitored can make a phone call or perform an operation such as the self-person and circumstance authentication while referring to the contents displayed on the display section 15.

The operation section 16 is used for the person being monitored in order to perform an operation of the mobile phone device 1 and is, for example, configured by an input section (e.g., switch and button).

FIG. 5 is a block diagram showing a specific structural example of the service center 3A in FIG. 3.

In FIG. 5, the service center 3A includes a control section 36, a first storage section, a second storage section, a third storage section, a first communication section 311 and a second communication section 312. The control section 36 performs the entire control of the service center 3A. The first storage section is provided as an information storage section 32 for the monitoring person for having a contact address of the monitoring person stored thereon. The second storage section is provided as an information storage section 33 for the person being monitored for identifying the person being monitored. The third storage section is provided as an activity range information storage section 34 for storing an activity range and a positional activity pattern of the person being monitored, which is set by the monitoring person or the person being monitored. The first communication section 311 is provided as a server-monitoring person communication section for performing a transmission and reception of data between the first communication section 311 and the mobile phone device 4 on the monitoring person side. The second communication section 312 is provided as a server-person being monitored communication section for performing a transmission and reception of data between the second communication section 312 and the mobile phone device 1 on the person being monitored. The communication section is configured by a communication control section 361A in the control section 36, the first communication section 311 and the second communication section 312.

The control section 36 includes a central processing unit section 361 having a CPU and a main program storage section 362 having a main control program stored thereon. The control of the entire service center 3A is performed based on the main control program. In the control section 36, an authentication request section 361B is provided in order to issue a self-person and circumstance request to the mobile phone device 1 on the person being monitored side which is provided as a terminal device on the person being monitored side. The authentication request section 361B can issue the self-person and circumstance authentication request to the mobile phone device 1 on the person being monitored side by using the aforementioned communication section when the relationship between (i) the positional information and (ii) a range stored in the activity range information storage section 34 (third storage section) has a predetermined relationship. Additionally, in the control section 36, an activity detection section 361C for detecting the relationship between the aforementioned positional information and the range stored in the activity range information storage section 34 is provided. The activity detection section 361C detects whether the positional information of the terminal device 1 on the person being monitored side is out of the previously set activity range or activity pattern. Thereafter, the control section 36 controls so as to: contact the terminal device 4 on the monitoring person side from the service center 3A which is a server to report whether the positional information of the terminal device 1 on the person being monitored side is out of the previously set activity range or activity pattern; request the self-person and circumstance authentication to the terminal device 1 on the person being monitored side from the server in accordance with the request from the terminal device 4 on the monitoring person side; obtain result information of the self-person and circumstance authentication, which has been performed at the terminal device 1 on the person being monitored side, at the service center 3A side; contact the terminal device 4 on the monitoring person side from the service center 3A side; and inform the terminal device 4 on the monitoring person side of the situation of the person being monitored based on the result information of the self-person and circumstance authentication.

In the first storage section (information storage section 32 for the monitoring person), information for identifying the monitoring person and information (e.g., ID, password and phone number) of a contact address of the monitoring person are stored. A plurality of contact addresses of the monitoring person may be stored in the first storage section.

In the second storage section (information storage section 33 for the person being monitored), information (e.g., ID, password and phone number) for identifying the person being monitored is stored.

In the third storage section (activity range information storage section 34), information of the activity range and a positional activity pattern of the person being monitored and the like, which have been set by the monitoring person or the person being monitored, is stored.

The first communication section 311 is connected to the mobile phone device 4 on the monitoring person side via the first data communication path A, which is capable of a bi-directional communication.

The second communication section 312 is connected to the mobile phone device 1 on the person being monitored side via the second data communication path B.

Owing to the structure described above, a safety confirmation method using the safety confirmation system according to the Embodiment will be described hereinafter.

As shown in FIG. 3, the monitoring person previously sets an activity range of the person being monitored in the service center 3A and registers the activity range of the person being monitored in the service center 3A by using the mobile phone device 4 via the first data communication path A. The data to be registered includes: information for identifying the monitoring person; information for the monitoring person containing a contact address (e.g., ID, password and phone number) of the monitoring person; information for the person being monitored containing information (e.g., ID, password, phone number and mail address) for identifying the person being monitored; and activity range information containing a normal activity range (e.g., area information of city, town and the like) and a positional activity pattern (when activity ranges differ from each other depending on time and the like) of the person being monitored. The information for the monitoring person, the information for the person being monitored and the activity range information are stored in the first storage section, the second storage section and the third storage section, respectively, of the service center 3A in FIG. 5. These information may be registered, by the person being monitored themselves by using the mobile phone device 1, in the service center 3A via the second date communication path B.

The person being monitored registers self-person and circumstance authentication information in the mobile phone device 1 based on an instruction for registration from the service center 3A. The self-person and circumstance authentication information relates to a finger print, iris of an eye, face and the like of the person being monitored. The Embodiment will be described using the finger print. For example, the person being monitored designates that an “SOS finger”, which is used for calling help at the time of an unusual event, is an index finger and “normal finger”, which is used for informing the safety of the person being monitored, when there is no problem. The person being monitored registers each finger print data and information corresponding to the finger print data in the first storage section 171 in the mobile phone device 1 shown in FIG. 4. The mobile phone device 1 informs the service center 3A of the completion of the registration of the self-person and circumstance authentication information. However, the finger print data is only registered in the mobile phone device 1 and is not registered in the service center 3A. This is for the protection of an individual's data. Additionally, the person being monitored performs a reception setting when a finger print authentication request (self-person and circumstance authentication request) is received in the case the person being monitored is out of their activity range or activity pattern.

The service center 3A obtains the positional information from the mobile phone device 1 of the person being monitored continuously via the second data communication path B and automatically determines whether the positional information of the mobile phone device 1 is out of the range set in the third storage section (activity range information storage section 34). When the positional information of the mobile phone device 1 is out of the range set in the third storage section (activity range information storage section 34), the service center 3A contacts the contact address (phone number) of the monitoring person, which is stored in first storage section (information storage section 32 for the monitoring person). When a plurality of contact addresses is set, the service center 3A first contacts the contact address with the first priority. When it is impossible to contact the contact address with the first priority (e.g., when the contact address with the first priority does not respond within the set time or when the mobile phone device 4 is outside the communication range), the service center 3A contacts a contact address with the second priority. When it is impossible to contact the contact address with the second priority, the service center 3A contacts a contact address with the next priority. Of the contact addresses which have not responded, an automatic response message is left from the service center 3A.

Based on: the reception of the self-person and circumstance authentication request from the monitoring person who have received the contact described above; or an automatic self-person and circumstance authentication request function provided in the service center 3A itself, the service center 3A issues the self-person and authentication request to the mobile phone device 1 and confirms the state of the person being monitored and the situation of the person being monitored.

For the self-person and circumstance authentication request from the monitoring person or the service center 3A, the person being monitored can recognize being called by a finger print authentication request due to the reception setting described above and can answer the phone after performing the finger print authentication: using the index finger, which is an “SOS finger”, when the person being monitored has determined that they are in a dangerous circumstance; or using the middle finger, which is a “normal finger”, when the person being monitored has determined that they are not in a dangerous circumstance.

Owing to this, when the person being monitored has strayed off the activity range on their own will, it is possible to inform the monitoring person of the data that the person being monitored is safe via the service center 3A by performing a verification using the middle finger. Additionally, if the circumstance allows a phone call to be made, the person being monitored can directly call the monitoring person via the phone communication line path C. On the other hand, when the person being monitored is out of the activity range against their own will and when the person being monitored is forcibly involved in a case such as abduction, it is possible to inform the monitoring person of the data of the “SOS (Help)” via the service center 3A by performing the verification using the index finger.

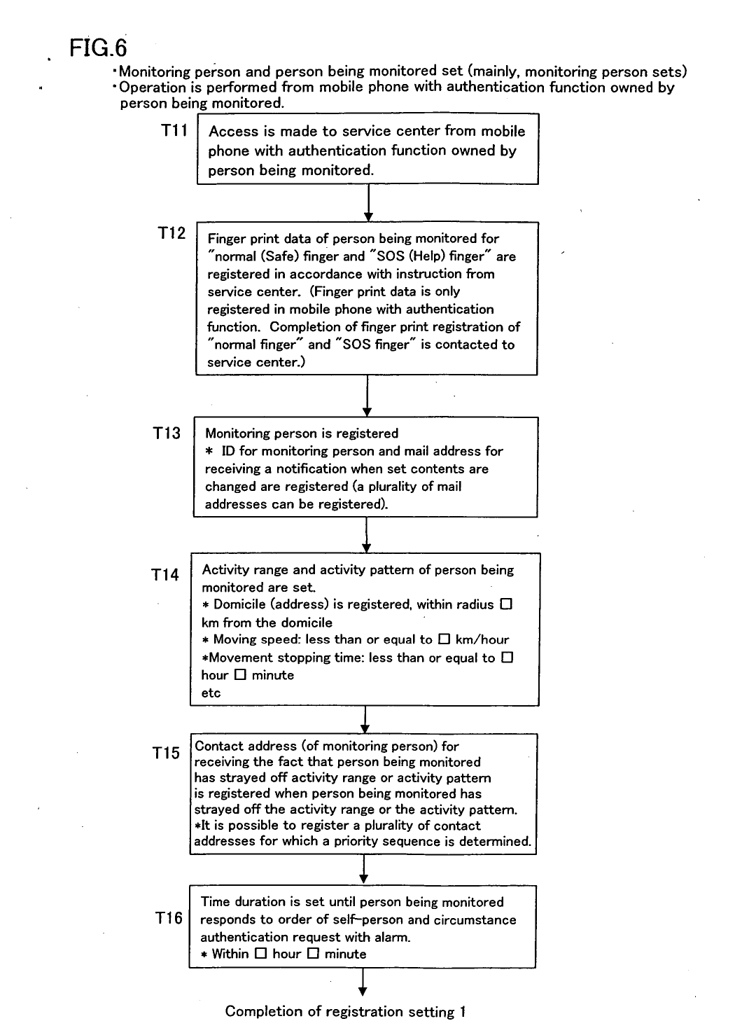

Hereinafter, the flow of the safety confirmation method according to the Embodiment will be described in detail with reference to FIGS. 6 to 10.

FIG. 6 is a flowchart for explaining a registration setting flow (No.1; registration-setting 1) to the service center 3A in FIG. 3.

The registration setting 1 is performed by the monitoring person and/or the person being monitored (mainly, monitoring person), and a registration operation is performed from the mobile phone device 1 of the person being monitored. The flow of the registration setting 1 is as follows.

As shown in FIG. 6, first, in step T11, the monitoring person or the person being monitored accesses the service center 3A from the mobile phone device 1 on the person being monitored side.

Next, in step T12, finger print data of the person being monitored for the “normal (Safe) finger” and the “SOS (Help) finger” are registered in the mobile phone device 1 on the person being monitored side in accordance with an instruction from the service center 3A. The finger print data is only registered in the mobile phone device 1. The completion of the finger print registration of each of the “normal finger” and the “SOS finger” is informed to the service center 3A from the mobile phone device 1.

Furthermore, in step T13, information for identifying the monitoring person is registered. Herein, an ID for the monitoring person and a mail address for receiving a notification when the set contents are changed are registered. It is possible to register a plurality of information for the monitoring person.

Furthermore, in step T14, an activity range of the person being monitored is set. In the next step T15, an activity range, and a positional and temporal activity pattern of the person being monitored are set.

Further, in step T15, when the person being monitored has strayed off the activity range or the activity pattern, a contact address of the monitoring person for receiving the information that the person being monitored has strayed off the activity range or the activity pattern is registered. It is possible to register a plurality of contact addresses for which a priority sequence is determined.

Still furthermore, in step T16, since the registration setting described above is used as a standard for determining whether the person being monitored is in an unusual situation or in a normal situation, the process of the registration setting 1 is completed after a time period is set until the person being monitored responds to the instruction of the self-person and circumstance authentication request with alarm.

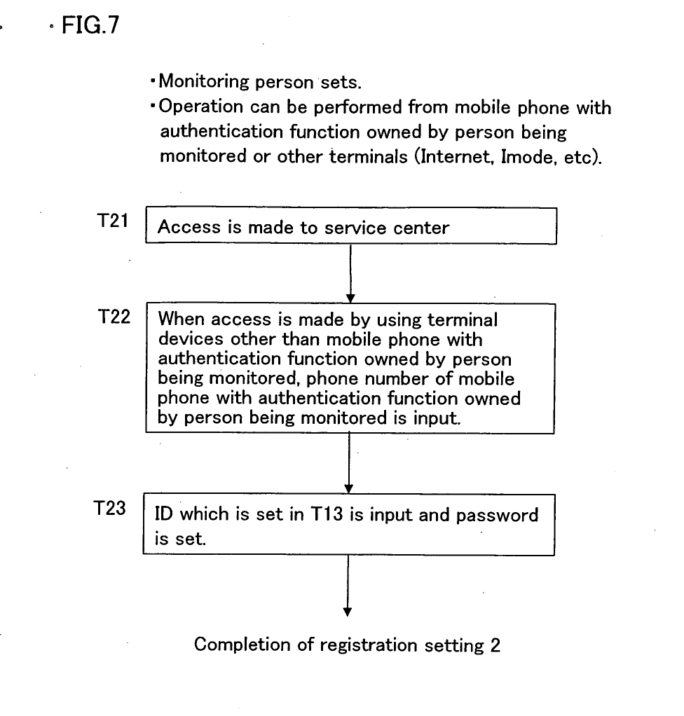

FIG. 7 is a flowchart for explaining a flow of registration setting (No.2; registration setting 2) to the service center in FIG. 3. This registration setting 2 is performed by the monitoring person, and, alternatively, can be performed from the mobile phone device 1 on the person being monitored side or other terminal devices (e.g., the Internet and Imode (which is produced by a Japanese phone company)). The flow of the registration setting 2 is as follows.

When the registration setting 1 in accordance with the flow diagram for the registration setting 1 shown in FIG. 6 is completed, first, in step T21, the monitoring person accesses the service center 3A from the mobile phone device 1 on the person being monitored side or other mobile terminal devices. Herein, when the monitoring person accesses the service center 3A by using terminal devices other than the mobile phone device 1 on the person being monitored side, in step T22, the monitoring person inputs the phone number of the mobile phone device 1 on the person being monitored side.

Next, in step T23, when the monitoring person inputs the ID of the monitoring person, which is set in step T13 for the registration setting 1, and sets a password, the process of the registration setting 2 is completed.

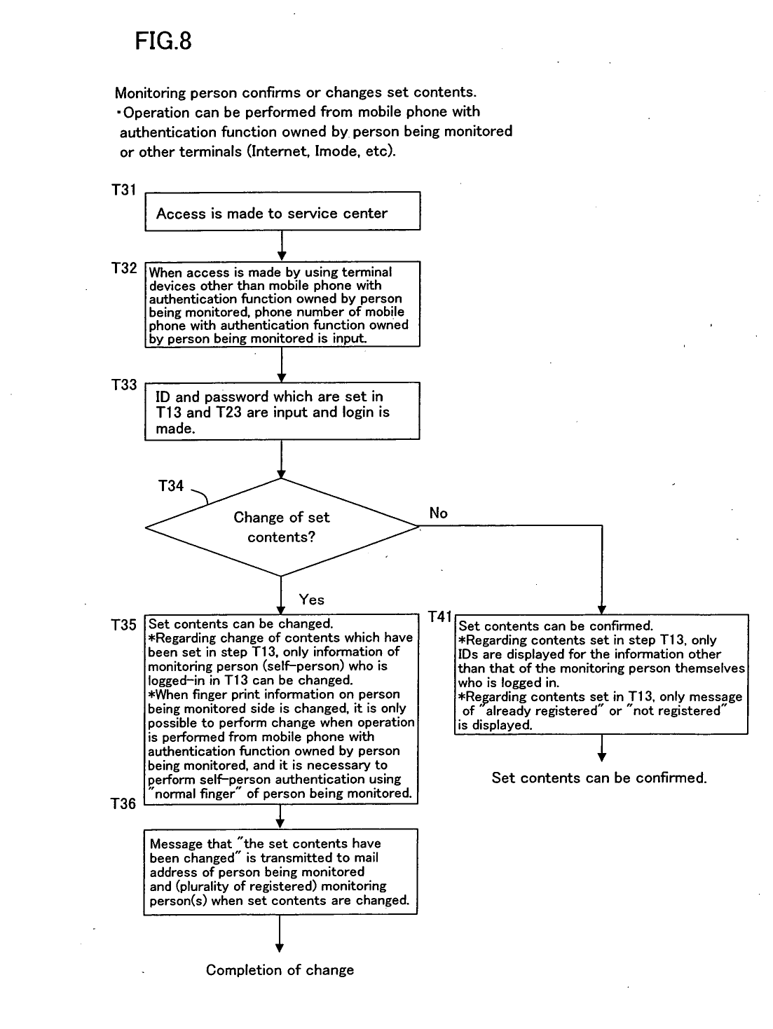

FIG. 8 is a flowchart for explaining the flow of the change of the registered contents for the service center in FIG. 3.

The change of the registered contents are performed such that the monitoring person confirms or changes the registered contents, and can be operated from the mobile phone device 1 on the person being monitored side or other mobile phone devices (e.g., the Internet and Imode). The change of contents of the registration setting 1 and the registration setting 2 described above can be only performed by the person being monitored, and the person being monitored cannot change the set contents. The flow of the change of the registered contents is as follows.

As shown in FIG. 8, first, in step T31, the monitoring person accesses the service center 3A from the mobile phone device 1 on the person being monitored side or other mobile terminal devices. Herein, when the monitoring person accesses the service center 3A by using terminal devices other than the mobile phone device 1 on the person being monitored side, in step T32, the monitoring person inputs the phone number of the mobile phone device 1 on the person being monitored side.

Next, in step T32, the monitoring person logs into the mobile phone device 1 by inputting the ID and the password of the monitoring person, which have been set in step T13 of the registration setting 1 and set in step T23 of the registration setting 2 described above.

Furthermore, in step T34, the monitoring person confirms whether to change the registered set contents. When the registered set contents are changed (YES) in step T34, the process proceeds to the next step T35, and the set contents can be changed. However, regarding the change of the contents which have been set in step T13 for the registration setting 1, only the information of the monitoring person, who is logged in, can be changed. When the finger print information on the person being monitored side is changed, it is only possible to perform the change when the operation is performed from the mobile phone device 1 on the person being monitored side, and it is necessary to perform the self-person and circumstance authentication using the “normal finger” of the person being monitored.

When the set contents described above are changed, in the next step T36, a message that “the set contents have been changed” is transmitted to the mail address of the person being monitored and the monitoring person, the mail address being set in step T13 of the registration setting 1, and then, the process of the change of the set contents is completed. Herein, when a plurality of persons monitoring are registered, the message is transmitted to each monitoring person.

On the other hand, when the registered set contents are not changed but confirmed (NO) in step T34, the process proceeds to the next step T41, where the set contents can be confirmed. However, regarding the contents set in step T13 of the registration setting 1, only IDs are displayed for the information other than that of the monitoring person who is logged in. Regarding the finger print information of the person being monitored, only a message of “already registered” or “not registered” is displayed. Accordingly, the process of the confirmation of the set contents is completed.

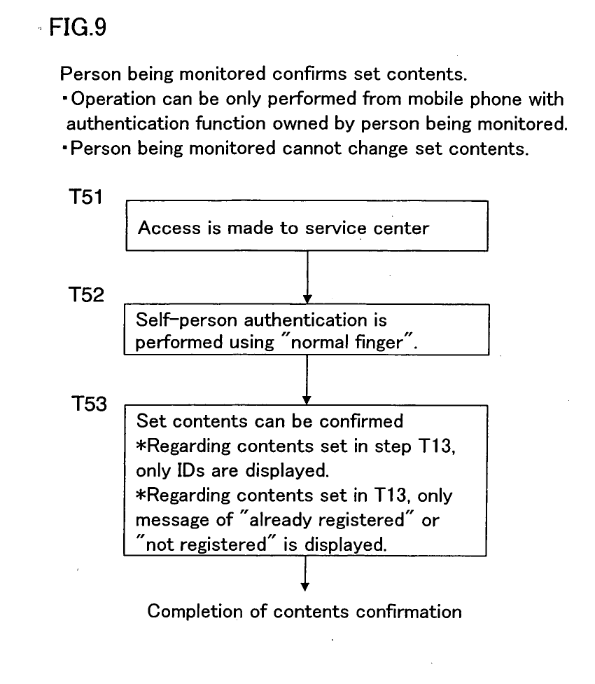

FIG. 9 is a flowchart for explaining the flow of the confirmation of the registered contents for the service center 3A in FIG. 3.

The confirmation of the registered contents is performed such that the person being monitored confirms the registered contents, and can only be operated from the mobile phone device 1 on the person being monitored side. When the registered contents are confirmed, the person being monitored cannot change the set contents. The flow of the confirmation of the registered contents is as follows.

As shown in FIG. 9, first, in step T51, the person being monitored accesses the service center 3A from the mobile phone device 1 on the person being monitored side.

Next, the person being monitored performs the self-person and circumstance authentication using the “normal finger” in step T52 so that the person being monitored can confirm the set contents in step T53. When the registered contents are confirmed, regarding the finger print information of the person being monitored, only a message of “already registered” or “not registered” is displayed, and the process of the confirmation of the set contents is completed.

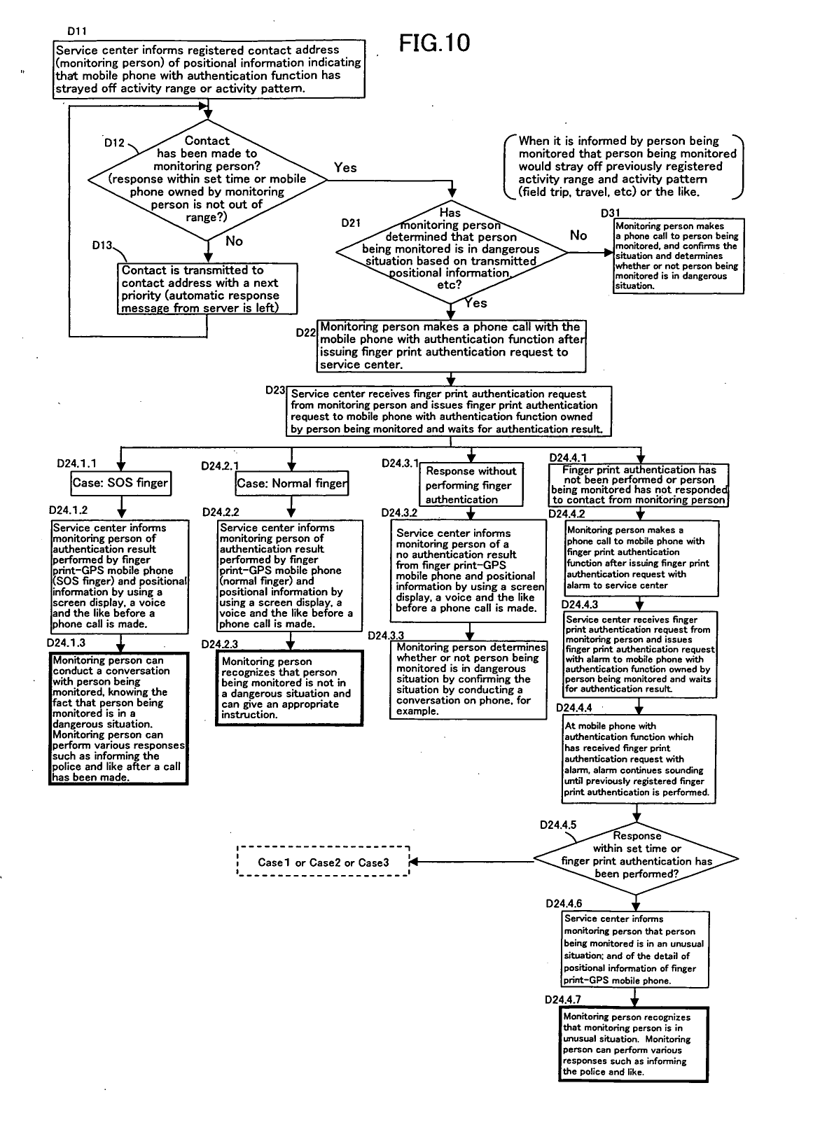

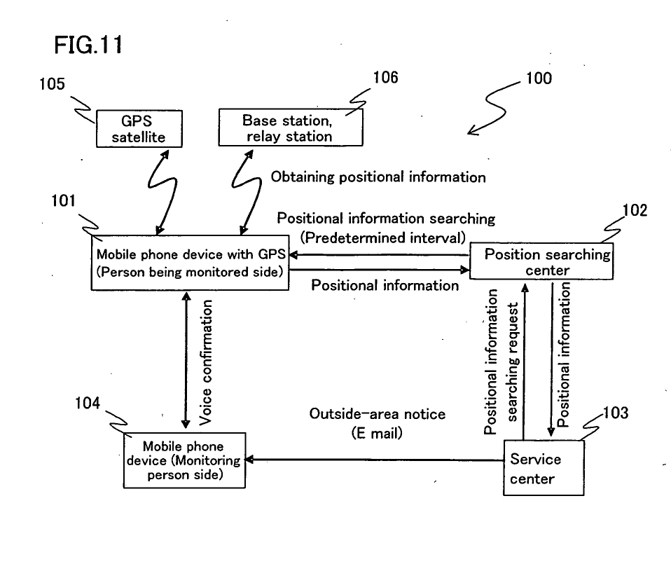

FIG. 10 is a flowchart for explaining the flow when the positional information of the mobile phone device 1 on the person being monitored side in FIG. 3 has strayed off the registered “activity range or activity pattern”.

As shown in FIG. 10, first, in step D11, when the positional information of the mobile phone device 1 on the person being monitored side has strayed off the activity range or the activity pattern, which has been set and registered from the mobile phone device 1 on the person being monitored side in step T14 of the registration setting 1, the service center 3A informs the monitoring person by contacting the contact address of the monitoring person, which has been registered in step T15, of the positional information that the mobile phone device 1 has strayed off the activity range or the activity pattern.

Next, in step D12, it is determined whether the contact has been successfully made to the monitoring person. When the contact has not been made to the monitoring person (NO) in step D12, the contact is transmitted to a contact address with a next priority in step D13. For the contact addresses to which the contact has not been made, an automatic response message from the service center 3A is left on this service center 3A which is a server.

In step D12, when the contact has been made to the monitoring person (YES), the monitoring person who has responded to the contact from the service center 3A determines whether the person being monitored is in a dangerous (unusual) circumstance based on the transmitted positional information in step D21.

In step D21, when the monitoring person has determined that the person being monitored is not in a dangerous (unusual) circumstance based on the transmitted positional information and the device side has detected that the monitoring person has performed some action (e.g., pushing a specific switch with a particular timing) on the device, then the process proceeds to step 31, and the monitoring person can contact the person being monitored by making a normal phone call and sending a mail, for example, and can confirm the circumstance of the person being monitored.

In step D21, when the monitoring person has determined that the person being monitored is in a dangerous (unusual) circumstance based on the transmitted positional information and the device side has detected that the monitoring person has performed some action (e.g., pushing a specific switch with a particular timing) on the device, then, in step D22, the monitoring person contacts the mobile phone device 1 on the person being monitored side after issuing a finger print authentication request to the service center 3A.

When the service center 3A receives the finger print authentication request from the mobile phone device 4 on the monitoring person side, in step D23, it issues the finger print request to the mobile phone device 1 with an authentication function and waits for the result of the process of the self-person and authentication.

In step D24.1.1, when the person being monitored has responded to the contact from the monitoring person by performing the self-person and circumstance authentication using the “SOS” finger (Case 1), then in step D24.1.2, the service center 3A informs the monitoring person of the authentication result (the fact that the self-person and circumstance authentication has been performed using the “SOS” finger) of the mobile terminal device 1 and the positional information by using a screen display, a voice and the like before a phone call is made. Thus, in step D24.1.3, the monitoring person can conduct a conversation with the person being monitored, knowing the fact that the person being monitored is in a dangerous circumstance. The monitoring person can perform various responses such as informing the police and the like after the call has been made.

In step D24.2.1, when the person being monitored has responded to the contact from the monitoring person by performing the self-person and circumstance authentication using the “normal” finger (Case 2), then, in step D24.2.2, the service center 3A informs the monitoring person of the authentication result (the fact that the self-person and circumstance authentication has been performed using the “normal” finger) of the mobile phone device 1 and the positional information by using a screen display, a voice and the like before a phone call is made. Thus, in step D24.2.3, the monitoring person can recognize that the person being monitored is not in a dangerous situation and can give an appropriate instruction.

In step D24.3.1, when the person being monitored has responded to the contact from the monitoring person without performing the finger authentication (Case 3), then, in step D24.3.2, the service center 3A informs the monitoring person of the authentication result (the fact that the self-person and circumstance authentication has not been performed) of the mobile phone device 1 and the positional information by using a screen display, a voice and the like before a phone call is made. Thus, in step D24.3.3, the monitoring person can determine whether or not the person being monitored is in a dangerous circumstance by confirming the circumstance by conducting a conversation on the phone, for example.

In step D24.4.1, when the finger print authentication has not been performed or the person being monitored has not responded to the contact from the monitoring person (Case 4), then, in step D24.4.2, the monitoring person contacts the mobile phone device 1 again after issuing the finger print authentication request with alarm to the service center 3A. In step D24.4.3, the service center 3A receives the finger print authentication request with alarm, then issues the finger print authentication request with alarm to the mobile phone device 1 and waits for the result of the authentication. In step D24.4.4, at the mobile phone device 1 which has received the finger print authentication request with alarm, the alarm continues sounding until the finger print authentication is performed by the holder (person being monitored) of the mobile phone device 1. In step D24.4.5, when there is no response from the mobile phone device 1 by the time which has been set in step T16 of the registration setting 1 (NO), then, in step D24.4.6, the service center 3A informs the monitoring person: that the person being monitored is in an unusual situation; and of the detail of the positional information of the mobile phone device 1. Thus, in step D24.4.7, the monitoring person can recognize that the monitoring person is in an unusual situation. The monitoring person can perform various responses such as informing the police and the like. In step D24.4.5, when there is a response from the mobile phone device 1 by the time which has been set in step T16 of the registration setting 1, the monitoring person can perform any response of D24.1.1, D24.2.1 and D24.3.1 in response to Cases 1 to 3.

As described above, according to the safety confirmation system 10 of the Embodiment, when a plurality of finger print data and information indicated by the data are previously registered, even in the case the person being monitored is in a dangerous circumstance (e.g., the person being monitored has been abducted) or the person being monitored is in an unusual situation (e.g., the mobile phone device has been lost), the monitoring person can recognize the state of the person being monitored.

In the Embodiment, as shown in FIG. 5, the first storage section as the information storage section 32 for the monitoring person for storing the information relating to the monitoring person; the second storage section as the information storage section 33 for the person being monitored for storing the information relating to the person being monitored; and the third storage section as the activity range information storage section 34 for storing the activity range and activity pattern of the person being monitored are provided in the service center 3A as the server. However, instead of this configuration, these can be provided in the terminal device (mobile phone device 1) on the person being monitored side. For example, as indicated by the broken line in FIG. 4, the second storage section 172 as the information storage section for the monitoring person; the third storage section 173 as the information storage section for the person being monitored; and the fourth storage section 174 as the activity range storage section can be provided in the mobile phone device 1.

Furthermore, although not specifically described in the Embodiment, when a back-up power supply section 19A as indicated by the broken line in FIG. 4, which can activate and deactivating the mobile phone device 1 on the person being monitored by performing a predetermined operation and which cannot be disconnected by normal operation, is provided in the mobile phone device 1 on the person being monitored side, in the case of a abduction and the like, even when the abductor has disconnected the power supply such that the person being monitored cannot respond, it is possible to obtain the positional information from the positional information obtaining section and also possible perform the self-person and circumstance authentication, by supplying power from the back-up power supply section 19A.

Furthermore, although, in the Embodiment, the self-person and the circumstance authentication is performed by using the finger print sensor as a sensor section, the self-person and circumstance authentication section can be a sensor section which is capable of performing an authentication of the monitored person by using various methods other than the iris of an eye, the face and the finger print data.

Furthermore, in the Embodiment, in order to obtain the positional information of the terminal device on the person being monitored, the positional information obtaining section 11 is provided for obtaining the positional information by the third communication section (information obtaining section) 133 from the GPS satellite 5 via the satellite communication path D. However, by using a position standard agency in addition to the GPS satellite or a satellite including a position augmentation system other than the GPS satellite, the DGPS information 19 can be obtained as positional information by the fourth communication section 134 via the DGPS communication path E as indicated by the broken line in FIG. 4. Alternatively, as shown in FIG. 1, the positional information can be obtained from the base station/relay station 6 for the mobile phone device. Instead, the positional information can be obtained by using the combination of these methods.

Furthermore, by proving the fifth storage section indicated by the broken line in FIG. 4 in the mobile phone device 1 as the positional information storage section 175 for storing the positional information of the mobile phone device 1, the positional information, of the terminal device, obtained by the positional information obtaining section 11 can be stored at each predetermined time. Thus, when the contact with the outside cannot be established by the communication section 13, the positional information and the clock time information of the terminal device can be stored in the positional information storage section 175. As the positional information storage section 175, the fourth storage section (positional information storage section 35) indicated by the broken line in FIG. 5 can be provided on the server (service center 3A) side. In this case, when the contact with the terminal device 4 on the monitoring person side cannot be established by the communication section, the fourth storage section (positional information storage section 35) at the server (service center 3A) side stores the positional information obtained from the terminal device 1 on the person being monitored side; and at least one of clock time information when the positional information has been obtained from the terminal device 1 on the person being monitored side, when the positional information has been obtained at the terminal device 1 on the person being monitored side (third communication section 133; position obtaining section) and when the contact with the terminal device 4 on the monitoring person side has not been established.

Furthermore, although not specifically described in the Embodiment, regarding the clock time information, clock time information from the GPS satellite can be stored together with the positional information in the positional information storage section 175. Furthermore, by providing a clock section 19B, as indicated by the broken line in FIG. 4, having a clock function of keep track of the time, clock time of the clock function of the clock section 19B can be stored as clock time information together with the positional information in the positional information storage section 175.

Furthermore, in the Embodiment, when the positional information, of the terminal device (mobile phone device 1), obtained by the positional information obtaining section 11 is out of range which is previously set in the activity range information storage section 34, the fact that the positional information obtaining section 11 is out of the range is informed to the monitoring person and then, the safety confirmation of the person being monitored is performed. However, even when the positional information of the terminal device (mobile phone device 1) is within the range which is previously set in the activity range information storage section 34, at each predetermined time, the fact that the positional information obtaining section 11 is within the range is informed to the monitoring person and then, the safety confirmation of the person being monitored can be performed.

Furthermore, when the positional information storage section 35 is provided, in the case where the positional information, of the terminal device, stored in the positional information storage section 35 is changing at a speed faster than or equal to that previously set, a safety confirmation of the person being monitored can be performed by contacting the monitoring person since something unusual may be happening to the person being monitored. Additionally, when the positional information, of the terminal device, stored in the positional information storage section 35 does not change for a time longer than or equal to that previously set, a safety confirmation of the person being monitored can be performed by contacting the monitoring person. Furthermore, when the positional information from the terminal device of the person being monitored cannot be obtained within a predetermined time, a safety confirmation of the person being monitored can be performed by contacting the monitoring person from the server (service center 3A) side.

Furthermore, in the Embodiment, the service center 3A obtains the positional information of the terminal device of the person being monitored at a predetermined interval. However, when the positional information of the terminal device of the person being monitored moves out of the range which is stored in the activity range information storage section 34, the positional information of the terminal device on the person being monitored can be obtained at an interval which is shorter than that of when the positional information of the terminal device of the person being monitored is within the activity range. On the contrary thereto, when the positional information of the mobile terminal device of the person being monitored moves within the range which is stored in the activity range information storage section 34, by obtaining the positional information at an interval which is longer than that of when the positional information of the terminal device of the person being monitored is outside the activity range, the used amount of the power supply of the mobile terminal device is reduced so that the positional information can be obtained for a longer time. Furthermore, when it is determined that the charge of the power supply of the terminal device on the person being monitored is low, by obtaining the positional information of the person being monitored at an interval which is longer than that of before the charge of the power supply of the terminal device on the person being monitored is determined to be low, the used amount of the power of the mobile terminal device is reduced so that the positional information can be obtained for a longer time.

Furthermore, in the Embodiment, the self-person and circumstance authentication information request is issued to the person being monitored (mobile phone device 1) from the server (service center 3A) by the authentication request section 361B in accordance with the request from the monitoring person. However, an automatic authentication request section can be provided as the authentication request section 361B on the server (service center 3A) side, the automatic authentication request section automatically issuing the self-person and circumstance authentication request to the person being monitored even without the request from the monitoring person. In this case, the self-person and circumstance authentication request is automatically issued when the positional information of the terminal device on the person being monitored side is out of the activity range, and the safety confirmation can be performed.

Furthermore, as indicated by the broken line in FIG. 4, when an audio output section 18 is provided in the mobile phone device 1, sound corresponding to the authentication request is stored in the audio output section 18, the sound representing a terminal beeping sound, and the stored sound is reproduced by reproducing the sound registered in the audio output section 18 when the self-person and circumstance authentication request is issued from the monitoring person to the person being monitored. Accordingly, the authentication request can be informed to the person being monitored without those around the person being monitored being aware that the authentication request is being performed. Furthermore, for example, the alarm output section 18A for generating an alarm sound is included as one mode in the audio output section 18 as indicated by the broken line in FIG. 4. The alarm output section 18A generates an alarm sound when the self-person and circumstance authentication request is issued, the authentication request section 361B, to the mobile phone device 1 as a terminal device on the person being monitored side from the mobile phone device 4 as a terminal device on the monitoring person or the server, and informs the person being monitored of the self-person and circumstance authentication request.

Furthermore, in the Embodiment, the activity detection section 361C for detecting the relationship between the positional information and the range stored in the activity range information storage section 34 is provided in the control section 36 on the service center 3A side. Alternatively, an activity detection section 141D for detecting the relationship between the positional information and the range stored in the activity range information storage section (fourth storage section 174) can be provided in the control section 14 of the mobile phone device 1 on the person being monitored side.

Furthermore, although not specifically described in the Embodiment, a speed detection section 141E or 361D is further provided in the mobile phone device 1 as a terminal device on the person being monitored side or the service center 3A as a server indicated by the broken lines in FIG. 4 and FIG. 5. The speed detection section 141E or 361D detects the moving speed with which the position of the positional information changes. The contact address of the terminal device (mobile phone device 4) on the monitoring person side and/or to the server (e.g., service center 3A) by using the aforementioned communication section is informed of the fact that the positional information is changes at a speed faster than or equal to that previously set when the positional information is changing at a speed faster than or equal to that previously set. Additionally, in a similar manner, the speed detection section 141E or 361D is further provided in the mobile phone device 1 or the service center 3A as a server. The speed detection section 141E or 361D detects the moving speed with which the position of the positional information changes. The contact address of the terminal device (mobile phone device 4) on the monitoring person side and/or to the server (e.g., service center 3A) by using the aforementioned communication section is informed of the fact that the positional information does not change for a time longer than or equal to that previously set when the positional information does not change for a time longer than or equal to that previously set. In this case, the speed detection section 141E or 361D detects the moving speed with which the position of the position information is changing, based on positional information stored in a fifth storage section 175 (position recorded information) at each predetermined time or positional information stored in the positional information storage section 35.

Furthermore, although not specifically described in the Embodiment, the server (e.g., service center 3A) and/or the information storage section 32 for the monitoring person and/or the second storage section 172 (information storage unit for the monitoring person as an information storage section for the monitoring person) in the mobile terminal device 1 on the person being monitored, one or more contact addresses of one or more terminal devices on one or more monitoring persons' side (for example, in the case of a person being monitored being a child, monitoring persons are both their parents) or a plurality of contact addresses (for example, in the case a person being monitored is a child, a plurality of contact addresses owned by their father who is a monitoring person) of a plurality of terminal devices on a monitoring person side along with the order of priority thereof can be stored.

Furthermore, a software causing a computer to execute the present invention will be also described.

The safety confirmation system 10, according to the Embodiment described above, is briefly described. Based on the control program and the data of the control program which are stored in the aforementioned main program storage sections 142 and 362, (i) a step of informing the terminal device 4 on the monitoring person side of the fact that the positional information of the terminal device 1 on the person being monitored side strays off the activity range or the activity pattern, which are previously set, from the server (service center 3) when the positional information of the terminal device 4 has strayed off; (ii) a step of requesting the self-person and circumstance authentication to the terminal device 1 on the person being monitored side from the server in accordance with a request from the terminal device 4 on the monitoring person side; and (iii) a step of obtaining result information of the self-person and the circumstance authentication, which has been performed at the terminal device 1 on the person being monitored side, on the server side and contacting the terminal device 4 on the monitoring person side from the server side, are performed on the server side. Based on the result information of the self-person and circumstance authentication, the circumstance of the person being monitored is informed to the terminal device 4 on the monitoring side.

Alternatively, when the server (service center 3) is not used, the function of the server is provided on the terminal device 1 side on the person being monitored side. In other words, regarding a safety confirmation system according to the present invention, (i) a step of informing the terminal device 4 on the monitoring person side of the fact that the positional information of the terminal device 1 on the person being monitored side has strayed off the activity range or the activity pattern, which are previously set, from the terminal device 1 on the person being monitored side when the positional information of the terminal device 1 has strayed off; (ii) a step of requesting the self-person and circumstance authentication to the terminal device 1 on the person being monitored side in accordance with a request from the terminal device 4 on the monitoring person side; and (iii) a step of informing the terminal device 4 on the monitoring person side of result information of the self-person and the circumstance authentication, which has been performed at the terminal device 1 on the person being monitored side, are performed on the terminal device 1 on the person being monitored side based on the control program and the data of the control program which are stored in the aforementioned main program storage sections 142 and 362. Based on the result information of the self-person and circumstance authentication, the circumstance of the person being monitored is informed to the terminal device 4 on the monitoring side.

Furthermore, the software causes a computer to execute a step of informing the terminal device 4 on the monitoring person side of the information indicating the fact that “the person being monitored is in a dangerous situation, contacting the person being monitored or informing the police” from the server and/or the terminal device 1 on the person being monitored side when the authentication result shows a dangerous situation although the result information of the self-person and circumstance authentication has been authenticated by the person being monitored.

Furthermore, the software causes a computer to execute a step of informing the terminal device 4 on the monitoring person side of the information indicating the fact that “the person being monitored is not in a dangerous situation, and can contact the person being monitored and give them an appropriate instruction” from the server and/or the terminal device 1 on the person being monitored side when the authentication result shows a normal situation and the result information of the self-person and circumstance authentication has been authenticated by the person being monitored.

Furthermore, the software causes a computer to execute a step of requesting the self-person and circumstance authentication request a plurality of times to the server or the terminal device 1 on the person being monitored side when the result information of the self-person and circumstance authentication has not been authenticated by the person being monitored, and then further informing the terminal device 4 on the monitoring person side of the information indicating the fact that “the person being monitored is in a dangerous situation, or the situation is unusual since the authentication has been performed by a third person” when the authentication by the person being monitored has not been obtained within a predetermined time period.

Furthermore, the software causes a computer to execute a step of requesting such that a warning be issued to the terminal device 1 on the person being monitored or outputting the warning to the terminal device 1 on the person being monitored side when the self-person and circumstance authentication process has not been performed at the server or the terminal device 1 on the person being monitored side and then further informing the terminal device 4 on the monitoring person side of the information indicating the fact that “the person being monitored is in a dangerous situation” when the self-person and circumstance authentication has not been obtained within a predetermined time period.

As described above, regarding a computer-readable recording medium, having a control program stored thereon for causing a computer to execute each step of the safety confirmation method described above, the main program storage sections 142 and 362 described above and other various storage sections are shown, and they are configured by a hard disk, an optical disc, a magnetic disk, an IC memory and the like. Additionally, the aforementioned program can be downloaded onto the main program storage sections 142 and 362 described above from the hard disk, the optical disc, the magnetic disk, the IC memory, a radio, the Internet and the like.

As described above, the present invention is exemplified by the use of its preferred Embodiment. However, the present invention should not be interpreted solely based on the Embodiment described above. It is understood that the scope of the present invention should be interpreted solely based on the claims. It is also understood that those skilled in the art can implement equivalent scope of technology, based on the description of the present invention and common knowledge from the description of the detailed preferred Embodiment of the present invention. Furthermore, it is understood that any patent, any patent application and any references cited in the present specification should be incorporated by reference in the present specification in the same manner as the contents are specifically described therein.

### INDUSTRIAL APPLICABILITY

According to the present invention, in the field of: a safety confirmation system capable of confirming the whereabouts and a currently placed circumstance (e.g., a safety circumstance) of a person being monitored (e.g., the elderly or children who require monitoring for safety) when the person being monitored is confronted by an incident (e.g., abduction); a safety confirmation method using the safety confirmation system; a terminal device on the person being monitored side and a server used for the safety confirmation system and the safety confirmation method; a control program for causing a computer to execute the safety confirmation method; and a computer-readable reading medium having the control program recorded thereon, when positional information of a person being monitored is out of a predetermined activity range or activity pattern, it is possible to inform a monitoring person of the fact that the positional information of the person being monitored is out of a predetermined activity range or activity pattern and inform the monitoring person of whether the person being monitored is in a dangerous situation or a safe situation by using a previously-registered personalized authentication method in response to a request from the monitoring person by mounting a self-person and circumstance authentication section on a terminal device having a positional information obtaining section (e.g., GPS locator-equipped mobile phone device).

When an authentication function (e.g., a finger print sensor) is provided in a terminal device (e.g., mobile phone device) carried by the person being monitored, it is possible to prevent a third person other than the person being monitored from responding by impersonating the person being monitored. Furthermore, if authentication information, which indicates whether the person being monitored is in a dangerous situation or a safe situation, is only known by the person being monitored, it is possible to contact the monitoring person of the authentication information without the third person being aware of it.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A terminal device on a person being monitored side, carried by the person being monitored, comprising:
a position obtaining section for obtaining positional information of the terminal device from a positional information providing section;
an activity range information storage section for storing information of an activity range and an activity pattern of the person being monitored, the activity range and the activity pattern being set by a monitoring person or the person being monitored;
an information storage section for a monitoring person for storing at least a contact address of the monitoring person;
an activity detection section for detecting the relationship between the positional information and the range stored in the activity range information storage section;
a communication section for informing the contact address of the terminal device on the monitoring person side of the relationship between the positional information and the stored range; and
a self-person and circumstance authentication section for performing a self-person and circumstance authentication process in accordance with a request from the terminal device on the monitoring person side in order to confirm the identity of the person being monitored and also to confirm the circumstance in which the person being monitored is being placed, wherein
a result information of the self-person and circumstance authentication indicating whether the circumstance in which the person being monitored is being placed is safe is informed to the terminal device on the monitoring person side by the communication section.

2. A terminal device on a person being monitored side, carried by the person being monitored, comprising:
a position obtaining section for obtaining positional information of the terminal device from a positional information providing section;
a communication section for sending the positional information to a server, and for receiving a self-person and circumstance authentication request from the server; and
a self-person and circumstance authentication section for performing a self-person and circumstance authentication process in accordance with the self-person and circumstance authentication request in order to confirm the identity of the person being monitored and also to confirm the circumstance in which the person being monitored is being placed, wherein
a result information of the self-person and circumstance authentication indicating whether the circumstance in which the person being monitored is being placed is safe is informed to the server side by the communication section.

3. A terminal device according to claim 1, wherein the self-person and circumstance authentication section has a plurality of self-person and circumstance authentication functions, the plurality of self-person and circumstance authentication functions being selectable in accordance with a state of the person being monitored, wherein
the self-person and circumstance authentication section is capable of informing the monitoring person or the server of the result information of the self-person and circumstance authentication by the self-person and circumstance authentication function selected by the person being monitored.

4. A terminal device according to claim 2, wherein the self-person and circumstance authentication section has a plurality of self-person and circumstance authentication functions, the plurality of self-person and circumstance authentication functions being selectable in accordance with a state of the person being monitored, wherein
the self-person and circumstance authentication section is capable of informing the monitoring person or the server of the result information of the self-person and circumstance authentication by the self-person and circumstance authentication function selected by the person being monitored.

5. A terminal device according to claim 3, further comprising an authentication information storage section for storing a plurality of self-person and circumstance authentication information, the plurality of self-person and circumstance authentication information being selectable in accordance with a state of the person being monitored, wherein
the self-person and circumstance authentication section performs the self-person and circumstance authentication process by using the self-person and circumstance authentication information which is stored in the authentication information storage section.

6. A terminal device according to claim 1, further comprising an authentication information storage section for storing a plurality of self-person and circumstance authentication information, the plurality of self-person and circumstance authentication information being selectable in accordance with a state of the person being monitored, wherein
the self-person and circumstance authentication section performs the self-person and circumstance authentication process by using the self-person and circumstance authentication information which is stored in the authentication information storage section.

7. A terminal device according to claim 4, further comprising an authentication information storage section for storing a plurality of self-person and circumstance authentication information, the plurality of self-person and circumstance authentication information being selectable in accordance with a state of the person being monitored, wherein
the self-person and circumstance authentication section performs the self-person and circumstance authentication process by using the self-person and circumstance authentication information which is stored in the authentication information storage section.

8. A terminal device according to claim 2, further comprising an authentication information storage section for storing a plurality of self-person and circumstance authentication information, the plurality of self-person and circumstance authentication information being selectable in accordance with a state of the person being monitored, wherein
the self-person and circumstance authentication section performs the self-person and circumstance authentication process by using the self-person and circumstance authentication information which is stored in the authentication information storage section.

9. A terminal device according to claim 5, wherein the self-person and circumstance authentication information is registered in the authentication information storage section, the self-person and circumstance authentication information indicating whether the person being monitored is in a safe situation or in a dangerous situation.

10. A terminal device according to claim 6, wherein the self-person and circumstance authentication information is registered in the authentication information storage section, the self-person and circumstance authentication information indicating whether the person being monitored is in a safe situation or in a dangerous situation.

11. A terminal device according to claim 7, wherein the self-person and circumstance authentication information is registered in the authentication information storage section, the self-person and circumstance authentication information indicating whether the person being monitored is in a safe situation or in a dangerous situation.

12. A terminal device according to claim 8, wherein the self-person and circumstance authentication information is registered in the authentication information storage section, the self-person and circumstance authentication information indicating whether the person being monitored is in a safe situation or in a dangerous situation.

13. A terminal device according to claim 1, wherein the self-person and circumstance authentication section includes a sensor section for sensing at least one of a finger print, an iris of an eye and a face, and
the self-person and circumstance authentication process is performed by verifying (i) the information of at least one of the finger print, the iris of the eye and the face measured by the sensor section and (ii) information of at least one of a finger print, an iris of an eye and a face registered corresponding to the information of at least one of the finger print, the iris of the eye and the face measured by the sensor section as the self-person and circumstance authentication information.

14. A terminal device according to claim 2, wherein the self-person and circumstance authentication section includes a sensor section for sensing at least one of a finger print, an iris of an eye and a face, and
the self-person and circumstance authentication process is performed by verifying (i) the information of at least one of the finger print, the iris of the eye and the face measured by the sensor section and (ii) information of at least one of a finger print, an iris of an eye and a face registered corresponding to the information of at least one of the finger print, the iris of the eye and the face measured by the sensor section as the self-person and circumstance authentication information.

15. A terminal device according to claim 6, wherein the a plurality of self-person and circumstance authentication information selectable in accordance with the state of the person being monitored includes a finger print information of one finger and a finger print information of another finger different from the one finger, and the self-person and circumstance authentication information is set in the authentication information storage section so as to indicate a safe situation when the person being monitored uses the finger print information of the one finger for verification and a dangerous situation when the person being monitored uses the finger print information of the another finger for verification.

16. A terminal device according to claim 13, wherein the a plurality of self-person and circumstance authentication information selectable in accordance with the state of the person being monitored includes a finger print information of one finger and a finger print information of another finger different from the one finger, and the self-person and circumstance authentication information is set in the authentication information storage section so as to indicate a safe situation when the person being monitored uses the finger print information of the one finger for verification and a dangerous situation when the person being monitored uses the finger print information of the another finger for verification.

17. A terminal device according to claim 8, wherein the a plurality of self-person and circumstance authentication information selectable in accordance with the state of the person being monitored includes a finger print information of one finger and a finger print information of another finger different from the one finger, and the self-person and circumstance authentication information is set in the authentication information storage section so as to indicate a safe situation when the person being monitored uses the finger print information of the one finger for verification and a dangerous situation when the person being monitored uses the finger print information of the another finger for verification.

18. A terminal device according to claim 14, wherein the a plurality of self-person and circumstance authentication information selectable in accordance with the state of the person being monitored includes a finger print information of one finger and a finger print information of another finger different from the one finger, and the self-person and circumstance authentication information is set in the authentication information storage section so as to indicate a safe situation when the person being monitored uses the finger print information of the one finger for verification and a dangerous situation when the person being monitored uses the finger print information of the another finger for verification.

19. A terminal device according to claim 1, wherein the information storage section for the monitoring person stores one or more contact addresses of one or more terminal devices on one or more monitoring persons' side or a plurality of contact addresses of a plurality of terminal devices on a monitoring person side along with the order of priority thereof can be stored.

20. A terminal device according to claim 1, wherein the positional information providing section includes a GPS satellite, a position augmentation system which uses a differential GPS (DGPS) other than the GPS satellite, a base station or relay station for a mobile phone device or a combination thereof.

21. A terminal device according to claim 2, wherein the positional information providing section includes a GPS satellite, a position augmentation system which uses a differential GPS (DGPS) other than the GPS satellite, a base station or relay station for a mobile phone device or a combination thereof.

22. A terminal device according to claim 1, further comprising a positional information storage section for storing the positional information at each predetermined time.

23. A terminal device according to claim 2, further comprising a positional information storage section for storing the positional information at each predetermined time.

24. A terminal device according to claim 22, further comprising a speed detection section for detecting a moving speed with which the position of the positional information changes, wherein
the contact address of the terminal device on the monitoring person side or the server is informed by using the communication section of the fact that the position of the positional information changes at the speed faster than or equal to that previously set when the position of the positional information changes at a speed faster than or equal to that previously set.

25. A terminal device according to claim 23, further comprising a speed detection section for detecting a moving speed with which the position of the positional information changes, wherein
the contact address of the terminal device on the monitoring person side or the server is informed by using the communication section of the fact that the position of the positional information changes at the speed faster than or equal to that previously set when the position of the positional information changes at a speed faster than or equal to that previously set.

26. A terminal device according to claim 22, further comprising a speed detection section for detecting a moving speed with which the position of the positional information changes, wherein
the contact address of the terminal device on the monitoring person side or the server is informed by using the communication section of the fact that the position of the positional information does not change for the time longer than or equal to that previously set when the position of the positional information does not change for a time longer than or equal to that previously set.

27. A terminal device according to claim 23, further comprising a speed detection section for detecting a moving speed with which the position of the positional information changes, wherein
the contact address of the terminal device on the monitoring person side or the server is informed by using the communication section of the fact that the position of the positional information does not change for the time longer than or equal to that previously set when the position of the positional information does not change for a time longer than or equal to that previously set.

28. A terminal device according to claim 1, wherein the contact address of the terminal device on the monitoring person side or the server is informed by using the communication section of the fact that the positional information is out of the range stored in the activity range information storage section when the positional information is out of the range stored in the activity range information storage section.

29. A terminal device according to claim 28, wherein the contact address of the terminal device on the monitoring person side or the server is informed at each predetermined time by using the communication section of the fact that the positional information is within the range stored in the activity range information storage section when the positional information is within the range stored in the activity range information storage section.

30. A terminal device according to claim 1, wherein the contact address of the terminal device on the monitoring person side or the server is informed at each predetermined time by using the communication section of the fact that the positional information is within the range stored in the activity range information storage section when the positional information is within the range stored in the activity range information storage section.

31. A terminal device according to claim 1, further comprising a backup power supply section having a power supply not being able to be disconnected by an external operation, wherein
even when a normal power supply is disconnected, the normal power supply is backed up by the backup power supply section, and the positional information obtaining section can at least obtain the positional information.

32. A terminal device according to claim 2, further comprising a backup power supply section having a power supply not being able to be disconnected by an external operation, wherein
even when a normal power supply is disconnected, the normal power supply is backed up by the backup power supply section, and the positional information obtaining section can at least obtain the positional information.

33. A terminal device according to claim 22, wherein when a contact with the terminal device on the monitoring person side cannot be established by the communication section, the positional information storage section stores the positional information obtained by the position obtaining section and clock time information when the positional information has been obtained by the position obtaining section.

34. A terminal device according to claim 23, wherein when a contact with the terminal device on the monitoring person side cannot be established by the communication section, the positional information storage section stores the positional information obtained by the position obtaining section and clock time information when the positional information has been obtained by the position obtaining section.

35. A terminal device according to claim 33, wherein the positional information storage section stores clock time information from a GPS satellite as the clock time information.

36. A terminal device according to claim 34, wherein the positional information storage section stores clock time information from a GPS satellite as the clock time information.

37. A terminal device according to claim 33, further comprising a clock section, wherein
the positional information storage section stores a clock time from the clock section as the clock time information.

38. A terminal device according to claim 34, further comprising a clock section, wherein
the positional information storage section stores a clock time from the clock section as the clock time information.

39. A terminal device according to claim 1, further comprising an alarm output section for generating an alarm sound, wherein
the alarm sound is generated by the alarm output section so as to notify the self-person and circumstance authentication request when a self-person and circumstance authentication request is issued from the terminal device on the monitoring person side or the server to the terminal device on the person being monitored side.

40. A terminal device according to claim 2, further comprising an alarm output section for generating an alarm sound, wherein
the alarm sound is generated by the alarm output section so as to notify the self-person and circumstance authentication request when a self-person and circumstance authentication request is issued from the terminal device on the monitoring person side or the server to the terminal device on the person being monitored side.

41. A terminal device according to claim 1, further comprising an audio output section for storing a terminal beeping sound corresponding to the self-person and circumstance authentication request and reproducing the stored sound, wherein
the sound registered in the audio output section is reproduced as to notify the self-person and circumstance authentication request when a self-person and circumstance authentication request is issued from the terminal device on the monitoring person side or the server to the terminal device on the person being monitored side.

42. A terminal device according to claim 2, further comprising an audio output section for storing a terminal beeping sound corresponding to the self-person and circumstance authentication request and reproducing the stored sound, wherein
the sound registered in the audio output section is reproduced as to notify the self-person and circumstance authentication request when a self-person and circumstance authentication request is issued from the terminal device on the monitoring person side or the server to the terminal device on the person being monitored side.

43. A terminal device according to claim 1, further comprising an information storage section for a person being monitored for storing information for identifying the person being monitored.

44. A terminal device according to claim 2, further comprising an information storage section for a person being monitored for storing information for identifying the person being monitored.

45. A server for monitoring a terminal device on a person being monitored side, comprising:
an activity range information storage section for storing an activity range and activity pattern of the person being monitored, the activity range and activity pattern of the person being monitored being set by a monitoring person or the person being monitored side;
an information storage section for a monitoring person for storing at least a contact address of the terminal device on the monitoring person;
a communication section for communicating with the terminal device on the person being monitored side and with the terminal device on the monitoring person side;
a positional information storage section for storing positional information obtained from the terminal device on the person being monitored side by using the communication section;
an activity detection section for detecting the relationship between the positional information and the range stored in the activity range information storage section; and
an authentication request section for issuing a self-person and circumstance authentication request to the terminal device on the person being monitored side by using the communication section when the relationship between the positional information and the range stored in the activity range information storage section has a predetermined relationship.

46. A server according to claim 45, wherein when the relationship has the predetermined relationship, the authentication request section informs the contact address of the terminal device on the monitoring person side of the fact that the relationship has the predetermined relationship, and issues the self-person and circumstance authentication request to the terminal device on the person being monitored side in accordance with a request from the terminal device on the monitoring person side.

47. A server according to claim 46, wherein when the relationship has the predetermined relationship, the authentication request section automatically issues the self-person and circumstance authentication request to the terminal device on the person being monitored side.

48. A server according to claim 45, wherein when the relationship has the predetermined relationship, the authentication request section automatically issues the self-person and circumstance authentication request to the terminal device on the person being monitored side.

49. A server according to claim 45, wherein when the positional information is out of the range stored in the activity range information storage section in the predetermined relationship, the positional information is obtained from the terminal device on the person being monitored side by using the communication section at an time interval shorter than that when the positional information is within the range.

50. A server according to claim 45, wherein when the positional information is out of the range stored in the activity range information storage section in the predetermined relationship, the positional information is obtained from the terminal device on the person being monitored side by using the communication section at an time interval longer than that when the positional information is within the range.

51. A server according to claim 50, wherein the positional information is obtained from the terminal device on the person being monitored side by using the communication section at an interval, when the remaining charge of the power supply of the terminal device on the person being monitored side is determined to be lower than a predetermined value, the interval being longer than that of before the remaining charge of the power supply of the terminal device on the person being monitored side is determined to be low.

52. A server according to claim 45, wherein the positional information is obtained from the terminal device on the person being monitored side by using the communication section at an interval, when the remaining charge of the power supply of the terminal device on the person being monitored side is determined to be lower than a predetermined value, the interval being longer than that of before the remaining charge of the power supply of the terminal device on the person being monitored side is determined to be low.

53. A server according to claim 52, wherein the determination that the remaining charge of the power supply of the terminal device on the person being monitored side is lower than the predetermined value determines that the remaining charge of the power supply is low when a received voltage level is lower than a predetermined value, the received voltage level received when the positional information is obtained from the terminal device on the person being monitored side by using the communication section.

54. A server according to claim 45, wherein the information storage section for the monitoring person stores one or more contact addresses of one or more terminal devices on one or more monitoring persons' side or a plurality of contact addresses of a plurality of terminal devices on a monitoring person side along with the order of priority thereof can be stored.

55. A server according to claim 54, wherein the contact address of the terminal device on the monitoring person side is informed by using the communication section of the fact that the positional information cannot be obtained from the terminal device on the person being monitored at each predetermined time when the positional information cannot be obtained from the terminal device on the person being monitored at each predetermined time, the contact address being stored in the information storage section for the monitoring person.

56. A server according to claim 45, wherein the contact address of the terminal device on the monitoring person side is informed by using the communication section of the fact that the positional information cannot be obtained from the terminal device on the person being monitored at each predetermined time when the positional information cannot be obtained from the terminal device on the person being monitored at each predetermined time, the contact address being stored in the information storage section for the monitoring person.

57. A server according to claim 45, wherein the positional information storage section stores the positional information obtained from the terminal device on the person being monitored side and clock time information when the positional information has been obtained from the terminal device on the person being monitored side.

58. A terminal device according to claim 45, further comprising an information storage section for a person being monitored for storing information for identifying the person being monitored.

59. A server according to claim 45, wherein the positional information storage section stores the positional information obtained at each predetermined time.

60. A server according to claim 57, wherein the positional information storage section stores the positional information obtained at each predetermined time.

61. A server according to claim 60, further comprising a speed detection section for detecting a moving speed with which the position of the positional information changes, wherein
the contact address of the terminal device on the monitoring person side is informed by using the communication section of the fact that the positional information changes at the speed faster than or equal to that previously set when the position of the positional information changes at a speed faster than or equal to that previously set.

62. A server according to claim 60, further comprising a speed detection section for detecting a moving speed with which the position of the positional information changes, wherein
the contact address of the terminal device on the monitoring person side is informed by using the communication section of the fact that the positional information does not change for the time longer than or equal to that previously set when the position of the positional information does not change for a time longer than or equal to that previously set.

63. A server according to claim 60, wherein when a contact with the terminal device on the monitoring person side cannot be established by the communication section, the positional information storage section stores (i) the positional information obtained from the terminal device on the person being monitored and (ii) at least one of clock time information when the positional information has been obtained from the position obtaining section, when the positional information has been obtained at the terminal device on the person being monitored and when a contact with the terminal device on the monitoring person side has not been be established.

64. A server according to claim 63, further comprising a clock section, wherein
the positional information storage section stores a clock time from the clock section as the clock time information.

65. A safety confirmation system, comprising:
a terminal device on a person being monitored side according to claim 2;
a server for monitoring the terminal device on the person being monitored side, comprising, the server comprising:
an activity range information storage section for storing an activity range and activity pattern of the person being monitored, the activity range and activity pattern of the person being monitored being set by a monitoring person or the person being monitored side;
an information storage section for a monitoring person for storing at least a contact address of the terminal device on the monitoring person;
a communication section for communicating with the terminal device on the person being monitored side and with the terminal device on the monitoring person side;
a positional information storage section for storing positional information obtained from the terminal device on the person being monitored side by using the communication section;
an activity detection section for detecting the relationship between the positional information and the range stored in the activity range information storage section; and
an authentication request section for issuing a self-person and circumstance authentication request to the terminal device on the person being monitored side by using the communication section when the relationship between the positional information and the range stored in the activity range information storage section has a predetermined relationship; and
a terminal device on a monitoring person side for monitoring the terminal device on the person being monitored side, the terminal device on the monitoring person side having a communication section for performing a communication with the terminal device on the person being monitored side and with the server, wherein
the terminal device on the monitoring person side is informed, from the terminal device on the person being monitored side and/or the server, of the fact that the positional information of the terminal device on the person being monitored side is out the activity range or activity pattern previously set when positional information of the terminal device on the person being monitored side is out an activity range or activity pattern previously set, a self-person and circumstance authentication is requested to the terminal device on the person being monitored side in accordance with a request from the terminal device on the monitoring person side so as to perform a self-person and circumstance authentication process, and result information of the self-person and circumstance authentication process is informed to the terminal device on the monitoring person side so as to notify the terminal device on the monitoring person side of the circumstance of the person being monitored based on the result information of the self-person and circumstance authentication process.

66. A safety confirmation system, comprising:
a terminal device on a person being monitored side according to claim 1; and
a terminal device on a monitoring person side for monitoring the terminal device on the person being monitored side, the terminal device on the monitoring person side having a communication section for performing a communication with the terminal device on the person being monitored side, wherein
the terminal device on the monitoring person side is informed by the terminal device on the person being monitored side of the fact that the positional information of the terminal device on the person being monitored side is out the activity range or activity pattern previously stored when positional information of the terminal device on the person being monitored side is out an activity range or activity pattern previously set, a self-person and circumstance authentication is requested to the terminal device on the person being monitored side in accordance with a request from the terminal device on the monitoring person side so as to perform a self-person and circumstance authentication process, and result information of the self-person and circumstance authentication process is informed to the terminal device on the monitoring person side so as to notify the terminal device on the monitoring person side of the circumstance of the person being monitored based on the result information of the self-person and circumstance authentication process.

67. A safety confirmation method controlled with a computer control using; a terminal device on the person being monitored side; a server; and a terminal device on a monitoring person side for monitoring the terminal device on the person being monitored side, the terminal device on the monitoring person having a communication section for performing a communication with the terminal device on the person being monitored side and with the server, respectively, the method on the server side comprising:
a step of informing the terminal device on the monitoring person side, from the server, of the fact that positional information of the terminal device on the person being monitored side is out an activity range or activity pattern previously set when the positional information of the terminal device on the person being monitored side is out the activity range or activity pattern previously set;
a step of requesting a self-person and circumstance authentication to the terminal device on the person being monitored side from the sever in accordance with a request from the terminal device on the monitoring person side; and
an authentication result information informing step of obtaining, at the server side, result information of the self-person and circumstance authentication which has been performed at the terminal device on the person being monitored side and contacting the terminal device on the monitoring person side from the server, wherein
a circumstance of the person being monitored is notified to the terminal device on the monitoring person side based on the result information of the self-person and circumstance authentication.

68. A safety confirmation method controlled with a computer control using; a terminal device on a person being monitored side according to claim 1, and a terminal device on a monitoring person side for monitoring the terminal device on the person being monitored side, the terminal device on the monitoring person having a communication section for performing a communication with the terminal device on the person being monitored side, the method on the terminal device on the person being monitored side comprising:
a step of informing the terminal device on the monitoring person side, from the terminal device on the person being monitored side, of the fact that positional information of the terminal device on the person being monitored side is out an activity range or activity pattern previously set when the positional information of the terminal device on the person being monitored side is out the activity range or activity pattern previously set;
a step of requesting a self-person and circumstance authentication to the terminal device on the person being monitored side in accordance with a request from the terminal device on the monitoring person side; and
an authentication result information informing step of informing the terminal device on the monitoring person side of result information of the self-person and circumstance authentication, the self-person and circumstance authentication which has been performed at the terminal device on the person being monitored side, wherein
a circumstance of the person being monitored is informed to the terminal device on the monitoring person side based on the result information of the self-person and circumstance authentication.

69. A safety confirmation method according to claim 67, wherein the result information of the self-person and circumstance authentication has been authenticated by the person being monitored and when an authentication result indicates a dangerous situation, the authentication result information informing step includes a step of informing the terminal device on the monitoring person side of information indicating “the person being monitored is in a dangerous situation, and thus inform the person being monitored or inform the police”.

70. A safety confirmation method according to claim 68, wherein the result information of the self-person and circumstance authentication has been authenticated by the person being monitored and when an authentication result indicates a dangerous situation, the authentication result information informing step includes a step of informing the terminal device on the monitoring person side of information indicating “the person being monitored is in a dangerous situation, and thus inform the person being monitored or inform the police”.

71. A safety confirmation method according to claim 67, wherein the result information of the self-person and circumstance authentication has been authenticated by the person being monitored and when an authentication result indicates a normal situation, the authentication result information informing step includes a step of informing the terminal device on the monitoring person side of information indicating “the person being monitored is not in a dangerous situation, and thus inform the person being monitored and give them an appropriate instruction”.

72. A safety confirmation method according to claim 68, wherein the result information of the self-person and circumstance authentication has been authenticated by the person being monitored and when an authentication result indicates a normal situation, the authentication result information informing step includes a step of informing the terminal device on the monitoring person side of information indicating “the person being monitored is not in a dangerous situation, and thus inform the person being monitored and give them an appropriate instruction”.

73. A safety confirmation method according to claim 67, wherein the result information of the self-person and circumstance authentication has not been authenticated by the person being monitored, the authentication result information informing step includes a step of requesting a self-person and circumstance authentication a plurality of times, and furthermore of informing the terminal device on the monitoring person side of information indicating “the person being monitored is in a dangerous situation, or an unusual situation exists in which the authentication has been performed by a third person” when the authentication by the person being monitored has not been obtained within a predetermined time.

74. A safety confirmation method according to claim 68, wherein the result information of the self-person and circumstance authentication has not been authenticated by the person being monitored, the authentication result information informing step includes a step of requesting a self-person and circumstance authentication a plurality of times, and furthermore of informing the terminal device on the monitoring person side of information indicating “the person being monitored is in a dangerous situation, or an unusual situation exists in which the authentication has been performed by a third person” when the authentication by the person being monitored has not been obtained within a predetermined time.

75. A safety confirmation method according to claim 67, wherein when the self-person and circumstance authentication process has not been performed, the authentication result information informing step includes a step of requesting that a warning be issued to the terminal device on the person being monitored side or outputting a warning to the terminal device on the person being monitored side, and furthermore of informing the terminal device on the monitoring person side of information indicating “the person being monitored is in a dangerous situation” when the authentication has not been performed within a predetermined time.

76. A safety confirmation method according to claim 68, wherein when the self-person and circumstance authentication process has not been performed, the authentication result information informing step includes a step of requesting that a warning be issued to the terminal device on the person being monitored side or outputting a warning to the terminal device on the person being monitored side, and furthermore of informing the terminal device on the monitoring person side of information indicating “the person being monitored is in a dangerous situation” when the authentication has not been performed within a predetermined time.

77. A control program for causing a computer to execute each step of a safety confirmation method according to claim 67.

78. A control program for causing a computer to execute each step of a safety confirmation method according to claim 68.

79. A computer-readable recording medium having a control program stored thereon according to claim 77.

80. A computer-readable recording medium having a control program stored thereon according to claim 80.
